(19) United States
(12) Patent Application Publication
(10) Pub. No.: US 2025/0224686 A1
(43) Pub. Date: Jul. 10, 2025

(54) IMAGE FORMING APPARATUS

(71) Applicant: CANON KABUSHIKI KAISHA, Tokyo (JP)

(72) Inventors: TOMOYA TATEISHI, Kanagawa (JP); OSAMU SASAOKA, Kanagawa (JP); SHUMA HIASA, Kanagawa (JP)

(21) Appl. No.: 19/004,075

(22) Filed: Dec. 27, 2024

(30) Foreign Application Priority Data
Jan. 5, 2024 (JP) 2024-000583
Jan. 5, 2024 (JP) 2024-000584
Nov. 26, 2024 (JP) 2024-205840

(51) Int. Cl. G03G 15/01

(52) U.S. Cl. CPC G03G 15/0173; G03G 15/0121

(57) ABSTRACT

An image forming apparatus includes (i) a development unit including a development frame including a development opening, a toner regulating portion configured to move to a cover position where the toner regulating portion covers the development opening and a retraction position where the toner regulating portion is retracted from the cover position, (ii) a rotary supporting the development unit, and (iii) a toner cartridge attachable to and detachable from the rotary and including a toner frame including a discharge port. In a case where the rotary is in a first posture, the development opening is in a position above the discharge port, and the toner regulating portion is in the cover position. In a case where the rotary is in a second posture, the development opening is in a position below the discharge port, and the toner regulating portion is in the retraction position.

### BACKGROUND OF THE INVENTION

### Field of the Invention

The present invention relates to an image forming apparatus that forms an image on a recording material.

### Description of the Related Art

A rotary development method for forming a color image by rotating a rotary including a plurality of development rollers in an electrophotographic image forming apparatus is known. Japanese Patent Application Laid-Open No. 2007-183305 and Japanese Patent Application Laid-Open No. 2008-096852 discuss an image forming apparatus including a rotary including a plurality of development rollers, and a plurality of toner cartridges (toner storage containers) attachable to and detachable from the rotary.

### SUMMARY OF THE INVENTION

The present invention is directed to providing an image forming apparatus in a novel form advanced from a conventional technique.

According to an aspect of the present invention, an image forming apparatus includes a development unit including a development roller, a development frame including a reception side storage chamber and a development opening communicating with the reception side storage chamber, a toner regulating portion configured to move to a cover position where the toner regulating portion covers the development opening and a retraction position where the toner regulating portion is retracted from the cover position, and an abutment portion linked to the toner regulating portion, a rotary supporting the development unit and configured to rotate about a rotational axis extending in an axis direction, a holding portion configured to abut the abutment portion, and a toner cartridge attachable to and detachable from the rotary, the toner cartridge including a toner frame including (i) a replenishment side storage chamber storing toner and (ii) a discharge port communicating with the replenishment side storage chamber, wherein in a case where the rotary rotates, the abutment portion moves relative to the holding portion, wherein in a case where the rotary is in a first posture, the development opening is in a position above the discharge port, and the holding portion and the abutment portion abut each other in such a manner that the toner regulating portion is in the cover position, and wherein in a case where the rotary is in a second posture, the development opening is in a position below the discharge port, the toner regulating portion is in the retraction position, and toner discharged from the discharge port is allowed to enter the reception side storage chamber.

According to another aspect of the present invention, an image forming apparatus includes a development unit including a development roller, a development frame including a reception side storage chamber and a development opening communicating with the reception side storage chamber, and a toner regulating portion configured to move to a cover position where the toner regulating portion covers the development opening and a retraction position where the toner regulating portion is retracted from the cover position, a rotary supporting the development unit and configured to rotate about a rotational axis extending in an axis direction, and a toner cartridge attachable to and detachable from the rotary, the toner cartridge including a toner frame including (i) a replenishment side storage chamber storing toner and (ii) a discharge port communicating with the replenishment side storage chamber, wherein the toner regulating portion is configured to move between the cover position and the retraction position under a weight of the toner regulating portion itself, wherein in a case where the rotary to which the toner cartridge is attached is in a first posture, and the development opening is in a position above the discharge port, an own weight of the toner regulating portion acts from the retraction position toward the cover position in such a manner that the toner regulating portion is in the cover position, wherein in a case where the rotary to which the toner cartridge is attached is in a second posture, the development opening is in a position below the discharge port, an own weight of the toner regulating portion acts from the cover position toward the retraction position in such a manner that the toner regulating portion is in the retraction position, and toner discharged from the discharge port is allowed to enter the reception side storage chamber, and wherein the toner regulating portion includes one end portion fixed to the development frame and an other end portion opposite to the one end portion, and in a case where the toner regulating portion moves between the cover position and the retraction position, the toner regulating portion elastically deforms between the one end portion and the other end portion.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus according to a first exemplary embodiment.

FIG. 2 is a diagram illustrating a configuration of the image forming apparatus according to the first exemplary embodiment.

FIG. 3 is a schematic diagram of a development unit, a toner cartridge, and a tray according to the first exemplary embodiment.

FIGS. 4A and 4B are cross-sectional views of the image forming apparatus according to the first exemplary embodiment.

FIG. 5 is a perspective view of a rotary main body according to the first exemplary embodiment.

FIGS. 6A to 6C are perspective views of the image forming apparatus according to the first exemplary embodiment.

FIGS. 7A and 7B are cross-sectional views of the image forming apparatus according to the first exemplary embodiment.

FIG. 8 is a diagram illustrating the rotary main body according to the first exemplary embodiment.

FIG. 9 is a diagram illustrating the rotary main body according to the first exemplary embodiment.

FIG. 10 is a diagram illustrating the rotary main body according to the first exemplary embodiment.

FIGS. 11A and 11B are diagrams illustrating a configuration regarding a movement of the tray according to the first exemplary embodiment.

FIGS. 12A and 12B are diagrams illustrating the configuration regarding the movement of the tray according to the first exemplary embodiment.

FIGS. 13A and 13B are cross-sectional views of the toner cartridge and the development unit according to the first exemplary embodiment.

FIG. 14 is a cross-sectional view of a rotary assembly according to the first exemplary embodiment.

FIGS. 15A and 15B are diagrams illustrating configurations of a cover and a linked portion according to the first exemplary embodiment.

FIGS. 16A and 16B are diagrams illustrating the configurations of the cover and the linked portion according to the first exemplary embodiment.

FIGS. 17A and 17B are cross-sectional views of the development unit according to the first exemplary embodiment.

FIGS. 18A to 18C are diagrams illustrating a rotary holder according to the first exemplary embodiment.

FIGS. 19A to 19C are diagrams illustrating a relationship between a rotation of the rotary main body and a movement of a projection portion relative to the rotary holder according to the first exemplary embodiment.

FIGS. 20A to 20C are diagrams illustrating configurations of a cover and a linked portion according to a second exemplary embodiment.

FIGS. 21A to 21C are diagrams illustrating the configurations of the cover and the linked portion according to the second exemplary embodiment.

FIGS. 22A and 22B are cross-sectional views of a toner cartridge and a development unit according to a third exemplary embodiment.

FIG. 23 is a cross-sectional view of a rotary assembly according to the third exemplary embodiment.

### DESCRIPTION OF THE EMBODIMENTS

Hereinafter, exemplary embodiments according to the present disclosure will be described with reference to the drawings.

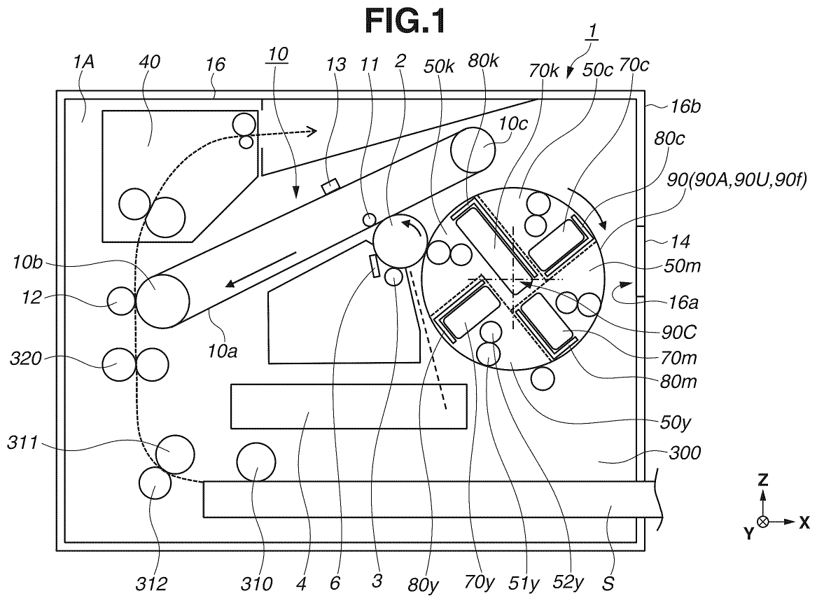

With reference to FIGS. 1 to FIGS. 12A and 12B, an image forming apparatus 1 according to a first exemplary embodiment is described.

In the following description and the drawings, a vertical direction in a case where the image forming apparatus 1 is installed on a horizontal plane is a Z-direction. A direction that intersects the Z-direction and is the direction of a rotational axis 90C of a rotary main body 90 (the rotational axis direction of a rotary) is a Y-direction. A direction intersecting both the Z-direction and the Y-direction is an X-direction. It is desirable that the X-direction and the Y-direction be a horizontal direction. It is desirable that the X-direction, the Y-direction, and the Z-direction be orthogonal to each other. The directions of arrows X, Y, and Z illustrated in the drawings are represented as a “positive X-side”, a “positive Y-side”, and a “positive Z-side”, and the opposite sides of the positive X-side, the positive Y-side, and the positive Z-side are represented as a “negative X-side”, a “negative Y-side”, and a “negative Z-side”, respectively, where necessary.

### (Overall Configuration of Image Forming Apparatus)

First, the overall configuration of the image forming apparatus 1 is described. The image forming apparatus 1 is a laser beam printer that forms an image on a sheet S by an electrophotographic method. More specifically, the image forming apparatus 1 is a color laser beam printer including four development units 50y, 50m, 50c, and 50k. As the sheet S that is a recording material (a recording medium), various sheet materials different in size and material, such as paper, e.g., plain paper or thick paper, a plastic film, cloth, a sheet material subjected to surface treatment, e.g., coated paper, and a sheet material having a special shape, e.g., an envelope or index paper, are usable.

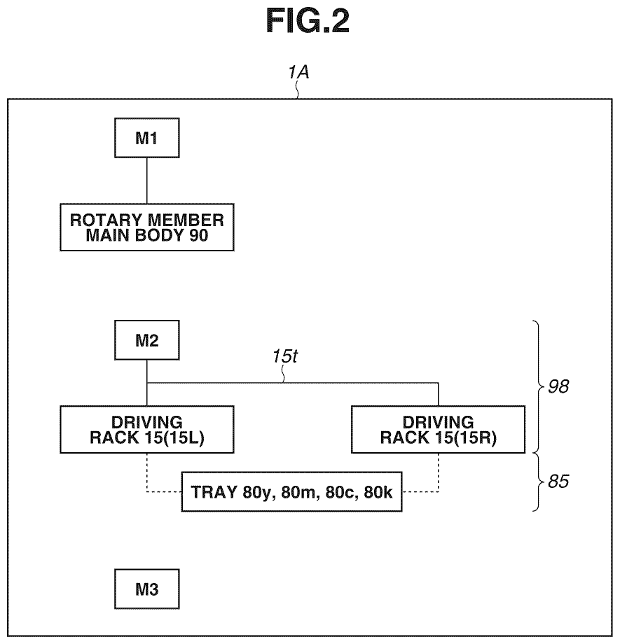

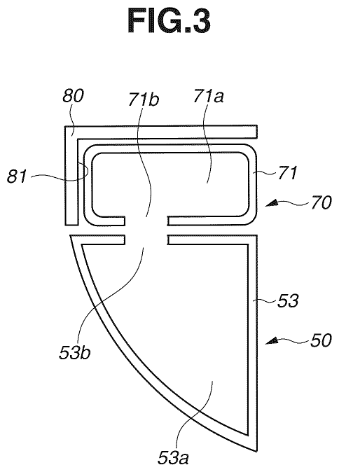

With reference to FIGS. 1, 2, and 3, the general configuration of the image forming apparatus 1 and an image forming operation are described. FIG. 1 is a schematic diagram illustrating a cross-sectional configuration of the image forming apparatus 1. FIG. 2 is a diagram illustrating driving sources of the image forming apparatus 1. FIG. 3 is a conceptual diagram illustrating a configuration for replenishing toner from a toner cartridge 70 to a development unit 50.

As illustrated in FIG. 1, the image forming apparatus 1 includes an image forming apparatus main body (hereinafter, “apparatus main body”) 1A and toner cartridges 70y, 70m, 70c, and 70k attachable to and detachable from the apparatus main body 1A. The apparatus main body 1A according to the present exemplary embodiment is a portion of the image forming apparatus 1 except for the toner cartridges 70y, 70m, 70c, and 70k.

The apparatus main body 1A of the image forming apparatus 1 includes an electrophotographic photosensitive member (hereinafter, “photosensitive drum”) 2 having a drum shape (a cylindrical shape) as an image bearing member that bears an electrostatic latent image. Around the photosensitive drum 2, a charging roller 3, a scanner 4 as an exposure device, and a cleaning unit 6 are placed.

The charging roller 3 is an example of a charging method or a charging unit for uniformly charging the photosensitive drum 2. The scanner 4 is an example of an exposure method or an exposure unit that exposes the photosensitive drum 2 by emitting laser light according to image information to the photosensitive drum 2. The scanner 4 emits laser light to the charged photosensitive drum 2, thereby forming an electrostatic latent image on the surface of the photosensitive drum 2. The cleaning unit 6 is an example of a cleaning method or a cleaning section that removes toner remaining on the surface of the photosensitive drum 2.

Further, the apparatus main body 1A includes a sheet storage portion 300, a pickup roller 310, a feed roller 311, a separation roller 312, a conveyance roller pair 320, a secondary transfer roller 12, a fixing device 40, and an intermediate transfer unit 10. The pickup roller 310 is an example of a feeding method or a feeding unit that feeds a sheet S. The feed roller 311 and the separation roller 312 are an example of a separation conveyance unit that conveys sheets S while separating the sheets S one by one by a frictional force. The secondary transfer roller 12 is an example of a transfer method or a transfer unit that transfers an image from an intermediate transfer belt 10a to a sheet S.

The intermediate transfer unit 10 includes the intermediate transfer belt 10a, a belt driving roller 10b, a tension roller 10c, a cleaning device 13, and a primary transfer roller 11. The intermediate transfer belt 10a is an example of an intermediate transfer member that bears an image transferred (primarily transferred) from the photosensitive drum 2 and conveys the image to transfer (secondarily transfers) the image to a sheet S. The intermediate transfer belt 10a is stretched by the belt driving roller 10b and the tension roller 10c. The belt driving roller 10b is a driving member that conveys the intermediate transfer belt 10a by being rotationally driven by a driving source.

The apparatus main body 1A includes a rotary main body (rotary, rotating body, or development device) 90 including development units 50y, 50m, 50c, and 50k. As described below, in the present exemplary embodiment, trays (supporting members) 80y, 80m, 80c, and 80k are attached to the rotary main body 90. The toner cartridges 70y, 70m, 70c, and 70k are detachably attached to the trays 80y, 80m, 80c, and 80k, respectively.

In the following description, a plurality of members having similar functions are distinguished with different numbers assigned to the individual members. For example, one of the toner cartridges 70y, 70m, 70c, and 70k is referred to as a “first toner cartridge”, one of the remaining three is referred to as a “second toner cartridge”, one of the remaining two is referred to as a “third toner cartridge”, and the last one is referred to as a “fourth toner cartridge”. Similarly, one of the trays 80y, 80m, 80c, and 80k is referred to as a “first tray”, one of the remaining three is referred to as a “second tray”, one of the remaining two is referred to as a “third tray”, and the last one is referred to as a “fourth tray”. That is, one of the trays 80y to 80k is an example of a first supporting member, another one of the trays 80y to 80k is an example of a second supporting member, yet another one of the trays 80y to 80k is an example of a third supporting member, and the last one of the trays 80y to 80k is an example of a fourth supporting member. This numbering is merely used for descriptive purposes, and the numbers are appropriately switched as a rule.

The development units (first to fourth development units) 50y, 50m, 50c, and 50k are examples of a development method or a development section that develops (visualizes) an electrostatic latent image formed on the photosensitive drum 2 into a toner image using toner of a color corresponding to the electrostatic latent image. The development units 50y, 50m, 50c, and 50k develop electrostatic latent images formed on the photosensitive drum 2 using yellow toner, magenta toner, cyan toner, and black toner, respectively. The development units 50y, 50m, 50c, and 50k may be placed in an order different from the order illustrated in FIG. 1.

The development unit 50y includes a development roller 51y, a supply roller 52y, and a development blade. The development roller 51y is a developer bearing member that rotates while bearing toner as a developer and supplies the toner to the photosensitive drum 2. The supply roller 52y is a supply member that is placed abutting the development roller 51y and supplies toner to the development roller 51y. The development blade is a regulation member that regulates the thickness of a toner layer borne on the development roller 51y. The other development units 50m, 50c, and 50k also include similar development rollers 51m, 51c, and 51k, similar supply rollers 52m, 52c, and 52k, and similar development blades, respectively.

The toner cartridges 70y, 70m, 70c, and 70k corresponding to the development units 50y, 50m, 50c, and 50k are attached to the rotary main body 90. Inside the toner cartridges 70y, 70m, 70c, and 70k, yellow toner, magenta toner, cyan toner, and black toner are stored as toner to be replenished to the development units 50y, 50m, 50c, and 50k, respectively. The toners are sometimes referred to as follows; toner of one of the four colors is first toner, toner of one of the remaining three colors is second toner, toner of one of the remaining two colors is third toner, and toner of the last color is fourth toner. For example, black toner is an example of the first toner, and magenta toner is an example of the second toner. This numbering is merely used for descriptive purposes, and the numbers are appropriately switched as a rule.

The rotary main body 90 includes a rotary frame 90f that supports the development units 50y, 50m, 50c, and 50k. The development units 50y, 50m, 50c, and 50k are supported by the rotary frame 90f that is a rotatable rotating supporting body.

The trays 80y, 80m, 80c, and 80k are attached to the rotary main body 90. A portion together with the rotary main body 90 and the trays 80y, 80m, 80c, and 80k is sometimes referred to as a “rotary unit 90U”. In other words, the rotary unit 90U includes the rotary main body 90 and the trays 80y, 80m, 80c, and 80k.

The toner cartridges 70y to 70k are detachably held by the trays 80y to 80k, respectively. Although described below, the trays 80y to 80k are supported to be movable in a sliding manner to outside the rotary main body 90. A portion together with the rotary unit 90U and the toner cartridges 70y, 70m, 70c, and 70k is sometimes referred to as a “rotary assembly 90A”. In other words, the rotary assembly 90A includes the rotary unit 90U and the toner cartridges 70y, 70m, 70c, and 70k.

As described below, the rotary main body 90 is rotatable about a rotational axis (rotational center) 90C. The rotational axis 90C coincides with the rotational axes of the rotary frame 90f, the rotary unit 90U, and the rotary assembly 90A. The rotational axis 90C is substantially parallel to the rotational axis (rotational center) of the photosensitive drum 2.

The rotary main body 90 rotates about the rotational axis 90Cwhich causes any of the development rollers 51y, 51m, 51c, and 51k to be in a development posture in which the corresponding development roller is opposed to the photosensitive drum 2. A posture in which the development roller 51y is opposed to the photosensitive drum 2 is referred to as a “yellow development posture”. A posture in which the development roller 51m is opposed to the photosensitive drum 2 is referred to as a “magenta development posture”. A posture in which the development roller 51c is opposed to the photosensitive drum 2 is referred to as a “cyan development posture”. A posture in which the development roller 51k is opposed to the photosensitive drum 2 is referred to as a “black development posture”. That is, the rotary main body 90 is rotatable about the rotational axis 90C so that the positions of the development rollers 51y, 51m, 51c, and 51k relative to the photosensitive drum 2 change. The black development posture is an example of a first development posture in which a first development roller (the development roller 51k) is opposed to the photosensitive drum 2. The other development postures are examples of a second development posture in which a second development roller (each of the development rollers 51y to 51c) is opposed to the photosensitive drum 2. The yellow, magenta, cyan, and black development postures are also be referred to as “first to fourth development postures”. This numbering is merely used for descriptive purposes, and the numbers are appropriately switched as a rule.

As illustrated in FIG. 2, the apparatus main body 1A includes motors M1, M2, and M3 as driving sources. As described below, the motor M1 supplies a driving force for rotating the rotary main body 90 about the rotational axis 90C. In other words, the motor M1 rotates the rotary assembly 90A and the rotary unit 90U about the rotational axis 90C.

The apparatus main body 1A includes a driving device 98 including the motor M2 and a transmission device. The transmission device includes driving racks 15L and 15R as driving gears and a transmission portion 15t. The driving force of the motor M2 is transmitted to the driving racks 15L and 15R by the transmission portion 15t. In other words, the motor M2 is configured to drive the driving racks 15L and 15R, and moves the trays 80y, 80m, 80c, and 80k relative to the rotary main body 90 through the driving racks 15L and 15R.

The motor M3 drives members other than the members driven by the motors M1 and M2. For example, the motor M3 drives the photosensitive drum 2, the development units 50y, 50m, 50c, and 50k, the pickup roller 310, the feed roller 311, the conveyance roller pair 320, the secondary transfer roller 12, the belt driving roller 10b, and the fixing device 40.

The members driven by the motors M1, M2, and M3 are appropriately changeable. Any two or all three of the roles of the motors M1, M2, and M3 may be integrated into a single motor. On the other hand, a driving source other than the motors M1, M2, and M3 may be added.

The indices “y”, “m”, “c”, and “k” assigned to the development units 50y, 50m, 50c, and 50k, the toner cartridges 70y, 70m, 70c, and 70k, and the trays 80y, 80m, 80c, and 80k indicate the colors of toner. The basic configurations and functions of the development units 50y, 50m, 50c, and 50k are similar to each other. The basic configurations and functions of the toner cartridges 70y, 70m, 70c, and 70k are similar to each other. The basic configurations and functions of the trays 80y, 80m, 80c, and 80k are similar to each other. Thus, in a case where the units, the cartridges, or the trays do not need to be distinguished from each other, the units, the cartridges, or the trays are described as any one of the four units, the four cartridges, or the four trays by omitting the indices “y”, “m”, “c”, and “k”.

As illustrated in FIG. 3, the toner cartridge 70 includes a toner frame 71. The toner frame 71 includes a toner storage portion 71a that stores toner, and a discharge opening 71b that communicates with the toner storage portion 71a.

The development unit 50 includes a development frame (storage frame) 53.

The development frame 53 includes a development side storage portion 53a, and a reception opening 53b that communicates with the development side storage portion (toner supply chamber) 53a. Although the development unit 50 includes the development roller 51 and the supply roller 52 as described above, these members are omitted in FIG. 3.

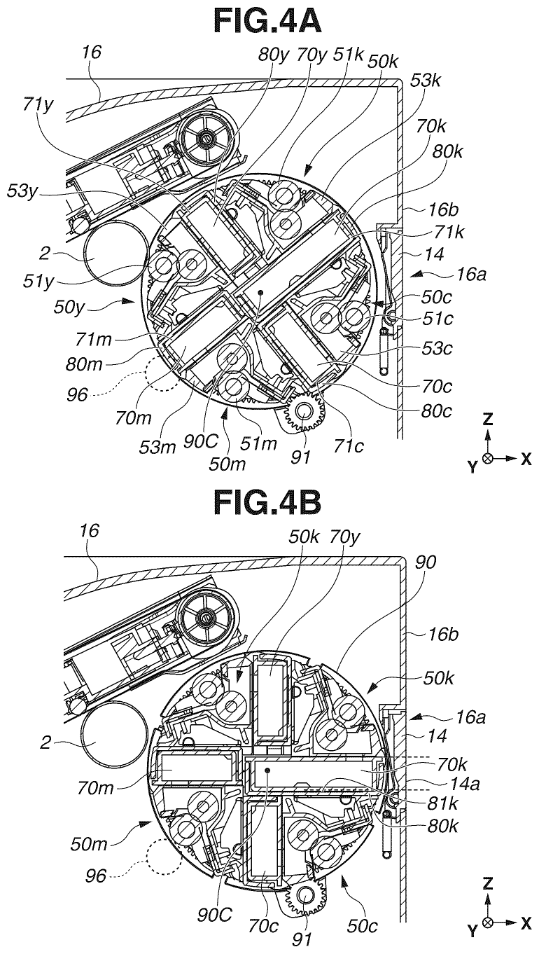

The development roller 51k included in the development unit 50k is an example of a first development roller. The development roller 51m included in the development unit 50m is an example of a second development roller. The development frame 53k (FIG. 4A) of the development unit 50k including the development side storage portion 53a is an example of a first storage frame including a first storage portion. The development frame 53m (FIG. 4A) of the development unit 50m including the development side storage portion 53a is an example of a second storage frame including a second storage portion. The rotary main body 90 is an example of a rotatable rotary including the first development roller, the second development roller, the first storage frame including the first storage portion, and the second storage frame including the second storage portion. In the present exemplary embodiment, the rotary main body 90 includes first to fourth development rollers and first to fourth storage frame bodies.

As described below, the toner cartridge 70 is movable to an attachment position and a retraction position where the toner cartridge 70 is retracted from the attachment position, relative to the development frame 53. In the state in which the toner cartridge 70 is in the attachment position relative to the development frame 53, the discharge opening 71b is opposed to the reception opening 53b. That is, the toner storage portion 71a of the toner cartridge 70 and the development side storage portion 53a of the development unit 50 communicate with each other through the discharge opening 71b and the reception opening 53b. In replenishment of toner from the toner cartridge 70 to the development unit 50, at least a part of the reception opening 53b is in a position below at least a part of the discharge opening 71b.

Then, toner stored in the toner storage portion 71a is discharged from the discharge opening 71b, and the toner discharged from the discharge opening 71b is stored in the development side storage portion 53a through the reception opening 53b. The toner stored in the development side storage portion 53a is supplied to the development roller 51 by the supply roller 52. Toner stored in the toner storage portion 71a is supplied to the development roller 51 through such a path.

It is desirable that the toner cartridge 70 include a sealing member (a first sealing member) (not illustrated) that covers the discharge opening 71b. It is desirable that the development unit 50 include a sealing member (a second sealing member) (not illustrated) that covers the reception opening 53b.

It is desirable that in the state in which the toner cartridge 70 is not attached to the development unit 50, the discharge opening 71b and the reception opening 53b be covered by the respective sealing members to prevent toner from leaking out from the discharge opening 71b and the reception opening 53b.

### (Image Forming Operation)

The image forming operation according to the present exemplary embodiment is described. First, the photosensitive drum 2 is rotated in the direction of an arrow (counterclockwise) in FIG. 1 in synchronization with the rotation of the intermediate transfer belt 10a. Then, the surface of the photosensitive drum 2 is uniformly charged by the charging roller 3.

In a case where a color image is formed on a sheet S, then as described below, the rotary main body 90 rotates in the direction of an arrow (clockwise) in FIG. 1 while supporting the development units 50y, 50m, 50c, and 50k. Then, an electrophotographic process is repeatedly performed while the development rollers 51y, 51m, 51c, and 51k are moved one by one to a development position.

First, the scanner 4 emits laser light based on image data corresponding to a yellow image, thereby forming an electrostatic latent image corresponding to the yellow image on the surface of the photosensitive drum 2. In parallel with the formation of the electrostatic latent image, the motor M1 rotates the rotary main body 90, whereby the rotary main body 90 is in the yellow development posture. When the rotary main body 90 is in the yellow development posture, the development roller 51y is in the development position and develops the electrostatic latent image formed on the photosensitive drum 2 using yellow toner.

In the present exemplary embodiment, each of the development rollers 51y, 51m, 51c, and 51k is an elastic roller with a rubber coating on the periphery of a metal shaft. At the development position, each of the development rollers 51y, 51m, 51c, and 51k develops an electrostatic latent image in the state in which the development roller is in contact with the photosensitive drum 2. That is, the image forming apparatus 1 according to the present exemplary embodiment employs a contact development method. At the development position, however, each of the development rollers 51y, 51m, 51c, and 51k may develop an electrostatic latent image in the state in which there is a gap between the development roller and the photosensitive drum 2. That is, the image forming apparatus 1 may employ a non-contact development method.

After development using the yellow toner, the yellow toner image on the photosensitive drum 2 is primarily transferred to the intermediate transfer belt 10a by the primary transfer roller 11 placed inside the intermediate transfer belt 10a.

From this point onward, the development rollers 51m, 51c, and 51k are sequentially moved to the development position by rotating the rotary main body 90, thereby forming toner images of the respective colors. That is, after the yellow toner image is formed on the intermediate transfer belt 10a, the rotary main body 90 is in the magenta development posture, and a magenta toner image is formed on the intermediate transfer belt 10a. After the magenta toner image is formed on the intermediate transfer belt 10a, the rotary main body 90 is in the cyan development posture, and a cyan toner image is formed on the intermediate transfer belt 10a. After the cyan toner image is formed on the intermediate transfer belt 10a, the rotary main body 90 is in the black development posture, and a black toner image is formed on the intermediate transfer belt 10a. After the black toner image is formed on the intermediate transfer belt 10a, the rotary main body 90 rotates about the rotational axis 90C in the direction of the arrow (clockwise) illustrated in FIG. 1 and returns to the yellow development posture. The color of an image to be formed first on the intermediate transfer belt 10a is optional, and for example, a black toner image may be formed first.

Then, primary transfer is repeated by superimposing the toner images of the four colors on the intermediate transfer belt 10a, thereby forming a color image on the intermediate transfer belt 10a. The secondary transfer roller 12 and the cleaning device 13 are not in contact with the intermediate transfer belt 10a until the color image is formed on the intermediate transfer belt 10a.

On the other hand, sheets S are fed by the pickup roller 310 from the sheet storage portion 300 provided in a lower portion of the apparatus main body 1A. The sheets S are sent to the conveyance roller pair 320 in the state in which the sheets S are separated one by one by the feed roller 311 and the separation roller 312. The conveyance roller pair 320 sends out the fed sheet S to a transfer portion (a secondary transfer portion) that is a nip portion between the intermediate transfer belt 10a and the secondary transfer roller 12. The color image on the intermediate transfer belt 10a is transferred (secondarily transferred) to the surface of the conveyed sheet S.

The sheet S to which the color image is transferred is sent to the fixing device 40. In the fixing device 40, the sheet S is heated and pressurized, thereby fixing the image to the sheet S. The sheet S passing through the fixing device 40 is discharged as a final product to outside the image forming apparatus 1.

On the other hand, in a case where a monochrome image is formed on a sheet S, the rotary main body 90 is in the black development posture. In this state, after an electrostatic latent image is formed on the surface of the photosensitive drum 2 by charging and exposing the photosensitive drum 2, the electrostatic latent image is developed using black toner by the development roller 51k which is in the development position. This black toner image is primarily transferred to the intermediate transfer belt 10a and then secondarily transferred to the sheet S. Subsequent steps are similar to those in the case of a color image.

### (Configuration of Rotary)

With reference to FIGS. 1, 4A, 4B, and 5, the configuration of the rotary main body 90 is described.

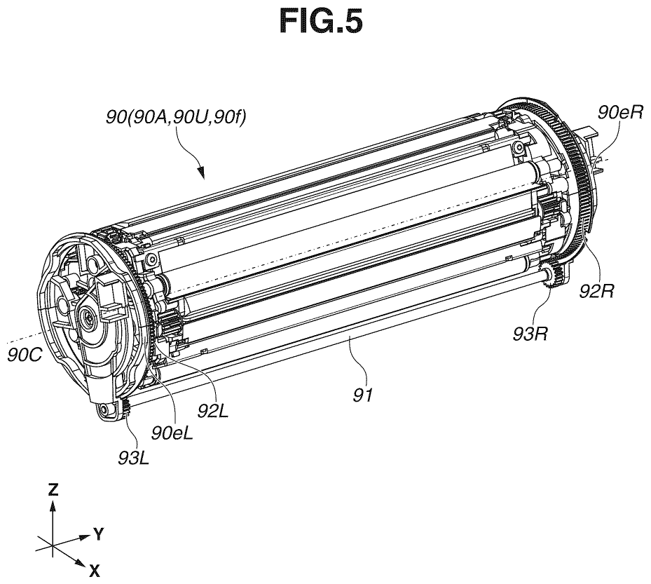

FIGS. 4A and 4B are cross-sectional views illustrating the rotary main body 90 of the image forming apparatus 1 and the periphery of the rotary main body 90. FIGS. 4A and 4B are cross-sectional views of the apparatus along a virtual plane perpendicular to the rotational axis 90C of the rotary main body 90. FIG. 5 is a perspective view of the rotary main body 90.

As described above, the toner cartridges 70y to 70k are attachable to and detachable from the rotary main body 90. In a case where toner in the toner cartridges 70y to 70k runs out, a user replenishes toner to the image forming apparatus 1 by replacing the toner cartridges 70y to 70k.

As illustrated in FIG. 1, the apparatus main body 1A includes a frame 16 that accommodates the rotary main body 90.

The frame 16 is a main body frame of the image forming apparatus 1 according to the present exemplary embodiment. The frame 16 is a housing (casing) of the apparatus main body 1A composed of a frame and an exterior member and is an approximately rectangular parallelepiped in the present exemplary embodiment.

The frame 16 includes an opening 16a. More specifically, the frame 16 includes a side surface 16b extending in a direction intersecting the horizontal direction. The side surface 16b constitutes at least a part of an exterior surface on the positive X-side of the apparatus main body 1A. The opening 16a is placed in the side surface 16b. In a discharge direction in which a sheet S on which an image is formed is discharged from a discharge port of the apparatus main body 1A, the side surface 16b is a side surface placed downstream of the discharge port. From the side surface 16b of the image forming apparatus 1, the user accesses the sheet storage portion 300 and replenish sheets S or acquire a sheet S discharged from the discharge port. Thus, the side surface 16b is referred to as the front surface of the apparatus main body 1A.

The toner cartridges 70y, 70m, 70c, and 70k are attachable to and detachable from the rotary main body 90 through the opening 16a. That is, the toner cartridge 70k is an example of a first toner cartridge that stores toner to be supplied to the first development roller (the development roller 51k) and is attachable to and detachable from the rotary (the rotary main body 90) through the opening 16a of the frame 16 of the apparatus main body 1A. The toner cartridge 70m is an example of a second toner cartridge that stores toner to be supplied to the second development roller (the development roller 51m) and is attachable to and detachable from the rotary (the rotary main body 90) through the opening 16a of the frame 16 of the apparatus main body 1A.

In the present exemplary embodiment, the toner cartridges 70y, 70m, 70c, and 70k are attached to and detached from the rotary main body 90 through the opening 16a in the state in which the toner cartridges 70y, 70m, 70c, and 70k are supported by the trays 80y to 80k, respectively.

In other words, the user attaches and detaches the toner cartridges 70y to 70k to and from the rotary main body 90 through the trays 80y to 80k, respectively.

The opening 16a is placed in the side surface 16b of the frame 16. In the present exemplary embodiment, the side surface 16b is a surface approximately parallel to the rotational axis 90C of the rotary main body 90. Thus, in a case where the toner cartridge 70 is replaced, the toner cartridge 70 passes through the opening 16a in a direction intersecting (desirably a direction orthogonal to) the rotational axis 90C.

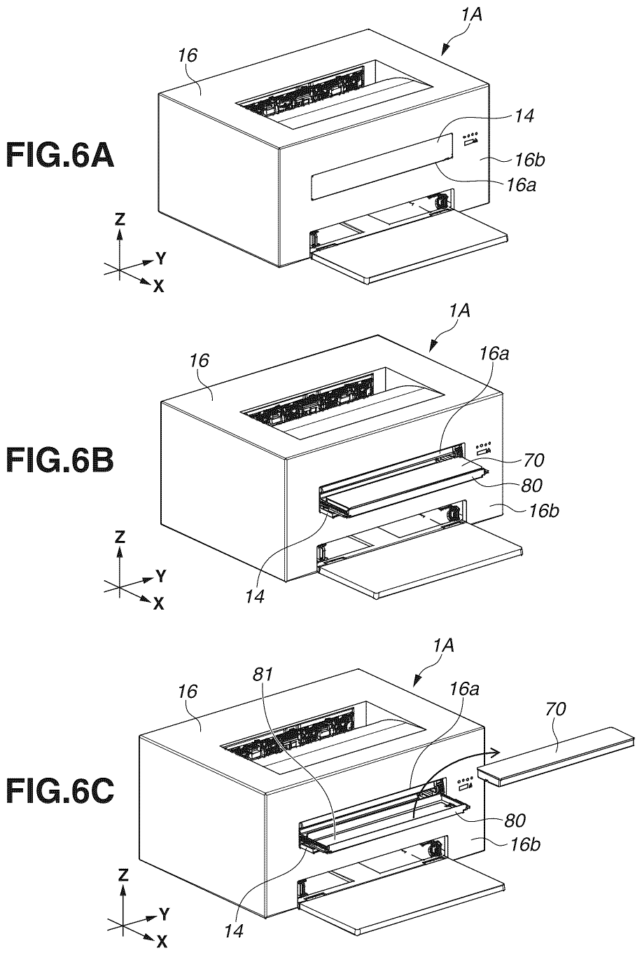

The image forming apparatus 1 includes a door 14 that covers the opening 16a of the frame 16. The door 14 is an opening/closing member movable to a closed position where the door 14 covers the opening 16a (see also FIG. 6A) and an open position where the opening 16a is exposed (see also FIGS. 6B and 6C).

As described above, in the present exemplary embodiment, the toner cartridge 70 is configured to be attachable to and detachable from the rotary main body 90 through the tray 80. Thus, the toner cartridge 70 is stably attached to and detached from the rotary main body 90.

More specifically, the user can replace the toner cartridge 70 by an operation of attaching and detaching the toner cartridge 70 to and from the tray 80 configured to be movable relative to the rotary main body 90 (i.e., relative to the apparatus main body 1A). In a configuration in which the user replaces a toner cartridge by directly inserting and removing the toner cartridge into and from an apparatus main body, the user needs to insert the toner cartridge to a predetermined attachment position in the apparatus main body. In the present exemplary embodiment, the tray 80 is movable so that the toner cartridge 70 moves to the attachment position in the state in which the tray 80 supports the toner cartridge 70. Thus, the user can replace the toner cartridge 70 by a simple operation of placing the toner cartridge 70 on the tray 80. This improves operability.

The toner cartridge 70 has a shape extending long and narrow such that the Y-direction parallel to the rotational axis 90C of the rotary main body 90 is the longitudinal direction of the toner cartridge 70. That is, the length in the longitudinal direction of the toner cartridge 70 is longer than the height and the width of the toner cartridge 70 in a cross section orthogonal to the longitudinal direction. In a case where the toner cartridge 70 having a long and narrow shape as described above is handled, the opening 16a is placed in the side surface 16b of the frame 16 approximately parallel to the longitudinal direction of the toner cartridge 70 (the Y-direction), whereby it is possible to pass the toner cartridge 70 through the opening 16a by a short moving distance. For example, it is easier to replace the toner cartridge 70 than a case where the toner cartridge 70 is inserted and removed through an opening on a side surface on either one side (the positive Y-side or the negative Y-side) of the frame 16 in the longitudinal direction of the toner cartridge 70.

The rotary main body 90 rotates about the rotational axis 90C, which causes any of the toner cartridges 70y to 70k to be in a replacement posture in which the corresponding toner cartridge is to be detached from the rotary main body 90. A posture in which the toner cartridge 70y is allowed to be detached is referred to as a “yellow replacement posture”. A posture in which the toner cartridge 70m is allowed to be detached is referred to as a “magenta replacement posture”. A posture in which the toner cartridge 70c is allowed to be detached is referred to as a “cyan replacement posture”.

A posture in which the toner cartridge 70k is allowed to be detached is referred to as a “black replacement posture”.

The black replacement posture is an example of a first replacement posture in which the first toner cartridge is allowed to be detached from the rotary main body 90. The yellow, magenta, and cyan replacement postures are examples of a second replacement posture in which the second toner cartridge is allowed to be detached from the rotary main body 90. The yellow, magenta, cyan, and black replacement postures are also be referred to as “first to fourth replacement postures”. This numbering is merely used for descriptive purposes, and the numbers are appropriately switchable as a rule.

The rotary main body 90 rotates clockwise in FIG. 1 about the rotational axis 90C, which causes the rotary main body 90 to be sequentially in the yellow, magenta, cyan, and black replacement postures. In the present exemplary embodiment, the rotary main body 90 rotates clockwise in FIG. 1 about the rotational axis 90C, thereby alternately switching a development posture and a replacement posture. For example, in FIG. 1, the rotary main body 90 is in the black development posture. The rotary main body 90 rotates clockwise from this state, whereby the posture of the rotary main body 90 is switched in the order of the cyan replacement posture, the yellow development posture, the black replacement posture, the magenta development posture, the yellow replacement posture, the cyan development posture, and the magenta replacement posture. The rotary main body 90 rotates clockwise from the magenta replacement posture, whereby the rotary main body 90 returns to the black development posture. That is, the rotary main body 90 is rotatable one or more rotations (360° or more) clockwise.

FIG. 4A illustrates a cross section of the rotary main body 90 in the state in which the rotary main body 90 is in a development posture (specifically, the yellow development posture). FIG. 4B illustrates a cross section of the rotary main body 90 in the state in which the rotary main body 90 is in a replacement posture (specifically, the black replacement posture).

As illustrated in FIGS. 4A and 4B, the four trays 80y to 80k are attached to the rotary main body 90. The toner cartridges 70y to 70k are held by the trays 80y to 80k, respectively. In FIGS. 4A and 4B, the trays 80y to 80k are in the state of being accommodated inside the rotary main body 90. This state is also referred to as the state in which the toner cartridges 70y to 70k are attached to the development units 50y, 50m, 50c, and 50k, respectively.

As described above, the toner cartridge 70 is movable to the attachment position and the retraction position where the toner cartridge 70 is retracted from the attachment position, relative to the development frame 53 of the development unit 50. That is, the first toner cartridge (the toner cartridge 70k) is movable to a first attachment position and a first retraction position relative to the first storage frame (the development frame 53k). The second toner cartridge (the toner cartridge 70m) is movable to a second attachment position and a second retraction position relative to the second storage frame (the development frame 53m).

In the state in which the toner cartridge 70 is in the attachment position relative to the development frame 53, then as illustrated in FIG. 3, the discharge opening 71b and the reception opening 53b are opposed to each other. In this state, the toner cartridge 70 is configured to supply toner to the development side storage portion 53a through the reception opening 53b (the opening of the storage frame).

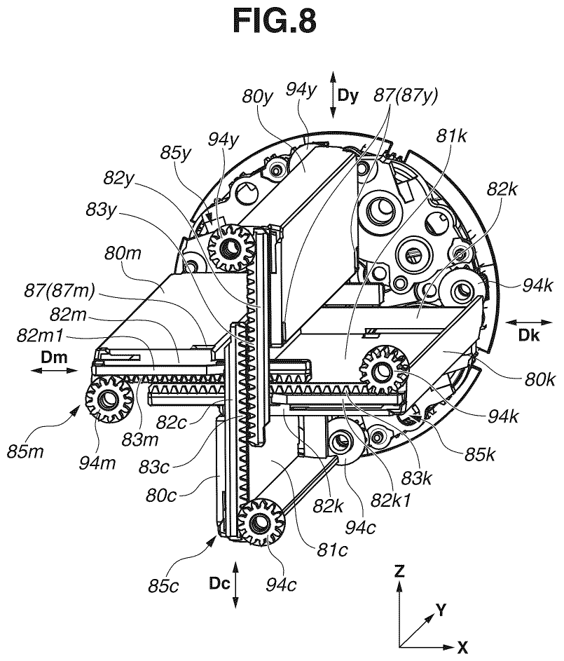

The apparatus main body 1A includes a movement device 85 configured to move the toner cartridge 70 from the attachment position to the retraction position relative to the rotary main body 90 (more specifically, relative to the development frame 53 of the development unit 50). The movement device 85 will be described below with reference to FIG. 8. In the present exemplary embodiment, in the rotary main body 90, a plurality of movement devices 85y to 85k corresponding to the plurality of toner cartridges 70y to 70k is placed. The trays 80y to 80k also serves as parts of the movement devices 85y to 85k, respectively.

In the present exemplary embodiment, the toner cartridge 70k that stores black toner has a size more than those of the toner cartridges 70y to 70c that store yellow toner, magenta toner, and cyan toner, respectively, and stores more toner. In other words, the first toner cartridge stores a first amount of toner, the second toner cartridge stores a second amount of toner, and the first amount is more than the second amount.

Specifically, the length of the toner cartridge 70k for black in a first radial direction relative to the rotational axis 90C of the rotary main body 90 is longer than the length of the toner cartridge 70m for magenta in a second radial direction. The first radial direction is the radial direction of the rotation of the rotary main body 90 (the radial direction of a virtual circle centered at the rotational axis 90C) and is the direction in which the toner cartridge 70k extends relative to the rotational axis 90C when viewed in the direction of the rotational axis 90C. The second radial direction is the radial direction of the rotation of the rotary main body 90 and is the direction in which the toner cartridge 70m extends relative to the rotational axis 90C when viewed in the direction of the rotational axis 90C. Similarly, the length of the toner cartridge 70k for black in the first radial direction is longer than the lengths of the toner cartridges 70y and 70c in radial directions corresponding to the other toner cartridges 70y and 70c.

Thus, the tray 80k that holds the toner cartridge 70k for black has a size more than those of the trays 80y to 80c that hold the other toner cartridges 70y, 70m, and 70c, respectively. That is, in the rotary main body 90, the four toner cartridges 70y to 70k different in size from each other and the four trays 80y to 80k different in size from each other are placed. In other words, the toner cartridge 70k as an example of the first toner cartridge and the toner cartridge 70y as an example of the second toner cartridge having a size less than that of the first toner cartridge are attachable to and detachable from the rotary main body 90. Accordingly, in the rotary main body 90, the tray 80k as an example of the first supporting member that supports the first toner cartridge and the tray 80y as an example of the second supporting member having a size less than that of the first supporting member are provided. The toner cartridges 70m and 70c as examples of a third toner cartridge and a fourth toner cartridge having sizes less than that of the first toner cartridge are attachable to and detachable from the rotary main body 90. Accordingly, in the rotary main body 90, the trays 80m and 80c as examples of the third supporting member and the fourth supporting member having sizes less than that of the first supporting member are provided.

With reference to FIG. 5, the rotational driving of the rotary main body 90 is described. As illustrated in FIG. 5, in both end portions of the rotary main body 90, disk gears 92L and 92R are formed. To both end portions of a swing shaft 91, rotary driving gears 93L and 93R are joined so that the rotary driving gears 93L and 93R transmit drive to the swing shaft 91. The driving force of the motor M1 is transmitted to the rotary driving gear 93R by a drive transmission mechanism. The driving force is transmitted to the disk gears 92L and 92R by the rotary driving gears 93L and 93R, respectively, whereby the rotary main body 90 is rotationally driven. The rotary main body 90 rotates clockwise in FIG. 1 about the rotational axis 90C.

The rotary main body 90 is supported swingably about the swing shaft 91. The rotary main body 90 is biased in the counterclockwise direction in FIGS. 4A and 4B about the swing shaft 91 by a biasing member (not illustrated). This direction is also referred to as the direction in which each of the development rollers 51y to 51k comes close to the photosensitive drum 2. As a result, in the state in which the rotary main body 90 is in a development posture, each of the development rollers 51y to 51k abuts the photosensitive drum 2.

On the other hand, as illustrated in FIG. 5, in both end portions of the rotary main body 90, rotary cams 90eL and 90eR are included. Clockwise rotation of the rotary main body 90 in FIGS. 4A and 4B about the rotational axis 90C causes the rotary cams 90eL and 90eR to abut a roller 96 (FIGS. 4A and 4B) supported by the frame 16. Then, the rotary cams 90eL and 90eR move in the clockwise direction in FIGS. 4A and 4B about the swing shaft 91. This direction is also referred to as the direction in which each of the development rollers 51y to 51k goes away from the photosensitive drum 2. This direction is also referred to as the direction in which the rotary main body 90 comes close to the opening 16a of the frame 16 and the door 14.

Consequently, when the rotary main body 90 rotates and shifts from a development posture to a replacement posture, the rotary main body 90 swings about the swing shaft 91. In the state in which the rotary main body 90 is in a replacement posture, the development roller 51 separates from the photosensitive drum 2.

As illustrated in FIG. 4B, in the black replacement posture, the toner cartridge 70k stops at a position opposed to the opening 16a provided in the side surface 16b of the apparatus main body 1A and the door 14. From this state, the tray 80k is moved in a sliding manner from the attachment position where the toner cartridge 70k is attached to the development unit 50k to outside the rotary main body 90, so that the user can replace the toner cartridge 70k.

### (Toner Cartridge Replacement Operation)

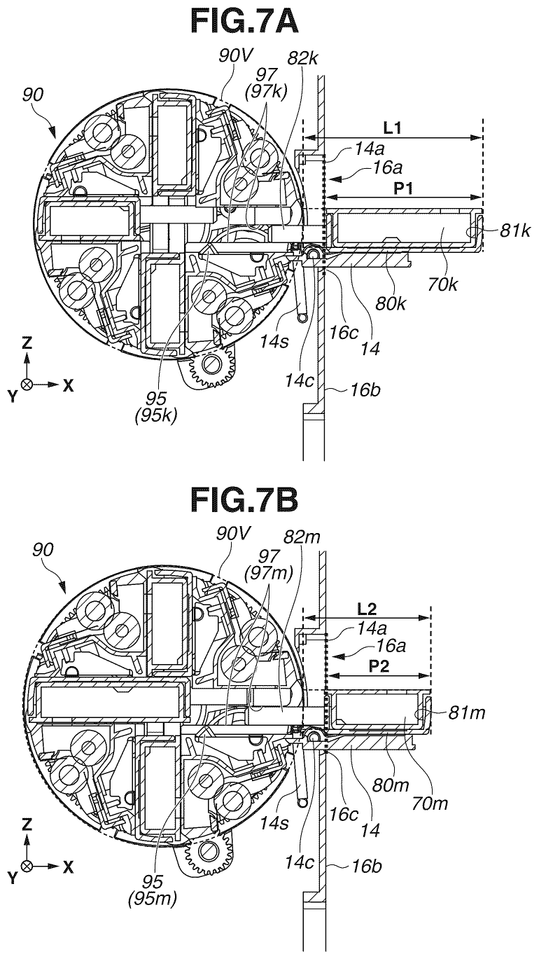

With reference to FIGS. 4A, 6A, 6B, 6C, 7A, and 7B, a toner cartridge replacement operation is described. FIGS. 6A to 6C are external views of the apparatus main body 1A. FIGS. 7A and 7B are cross-sectional views of the periphery of the rotary main body 90 in replacement of the toner cartridge 70. FIGS. 7A and 7B are cross-sectional views of the apparatus along a virtual plane perpendicular to the rotational axis 90C of the rotary main body 90.

FIG. 6A illustrates an external view of the apparatus main body 1A during the image forming operation and in a standby state. “During the image forming operation” refers to the state during the execution period of a series of operations from when the image forming apparatus 1 feeds a sheet S and forms an image on the sheet S to when the image forming apparatus 1 discharges the sheet S as a final product. The “standby state” refers to the state in which the image forming operation is ready to be started in response to the image forming apparatus 1 receiving an image forming instruction (a print instruction), and is the state in which the image forming apparatus 1 is waiting for an image forming instruction from the user. As illustrated in FIG. 6A, during the image forming operation and in the standby state, the door 14 is in a closed state.

FIG. 6B illustrates an external view of the apparatus main body 1A in replacement of the toner cartridge 70. In replacement of the toner cartridge 70, the door 14 is in an open state, and the tray 80 and the toner cartridge 70 are moved to outside the apparatus main body 1A.

The toner cartridge 70 is movable to the attachment position and the retraction position where the toner cartridge 70 is retracted from the attachment position, relative to the development frame 53 of the development unit 50. In the state in which the toner cartridge 70 is in the attachment position relative to the development frame 53, then as illustrated in FIG. 3, the discharge opening 71b and the reception opening 53b are opposed to each other. As illustrated in FIGS. 4A and 4B, the rotary main body 90 is configured to rotate about the rotational axis 90C and is in a development posture or a replacement posture in the state in which the toner cartridge 70 is in the attachment position.

The toner cartridge replacement operation is described. First, the user instructs a control section of the apparatus main body 1A to perform the toner cartridge replacement operation. For example, the instruction to perform the toner cartridge replacement operation is given by providing an input through an operation panel (an operation section) provided in the apparatus main body 1A.

In response to the control section receiving the instruction to perform the toner cartridge replacement operation, the rotary main body 90 rotates to the replacement posture of the toner cartridge 70 as a replacement target (the toner cartridge 70 that is out of toner) and stops. That is, the control section rotates the rotary main body 90 to the replacement posture of the toner cartridge 70 specified by the instruction to perform the toner cartridge replacement operation (the black replacement posture for replacement of the toner cartridge 70k for black in FIG. 4B). In the replacement posture, the tray 80 supporting the toner cartridge 70 to be replaced according to the instruction is opposed to the opening 16a of the frame 16 of the apparatus main body 1A.

For example, the rotary main body 90 in FIG. 4A is in the yellow development posture in which the yellow development roller 51y is opposed to the photosensitive drum 2. At this time, the toner cartridge 70k and the tray 80k for black may not need to be opposed to the opening 16a and the door 14. In other words, the toner cartridge 70 and the tray 80 may not need to be opposed to the opening 16a and the door 14 in a case where the rotary main body 90 is in a replacement posture or a development posture other than the replacement posture of the toner cartridge 70. Thus, the opening 16a may only need to be of a size that allows each toner cartridge 70 to individually pass through the opening 16a. Clockwise rotation of the rotary main body 90 in FIG. 4A by a predetermined angle from the yellow development posture causes, as illustrated in FIG. 4B, the toner cartridge 70k and the tray 80k for black to be opposed to the opening 16a and the door 14.

That “the tray 80 is opposed to the opening 16a” means that the tray 80 is set in a position to be movable to outside the apparatus main body 1A through the opening 16a. That is, in a case where the tray 80 is opposed to the opening 16a, movement of the tray 80 outward in the radial direction of the rotation of the rotary main body 90 by a movement mechanism allows the tray 80 and the toner cartridge 70 supported by the tray 80 to protrude to the outside of the apparatus main body 1A. In FIG. 4A, none of the trays 80y to 80k is opposed to the opening 16a. In FIG. 4B, only the tray 80k for black is opposed to the opening 16a, and the other trays 80y to 80c are not opposed to the opening 16a.

After positioning of the rotary main body 90 in the replacement posture, the motor M2 moves the tray 80 supporting the toner cartridge 70 as the replacement target to outside the apparatus main body 1A.

Consequently, the toner cartridge 70 as the replacement target moves from the attachment position to the retraction position relative to the rotary main body 90. As illustrated in FIGS. 6B, 6C, 7A, and 7B, the tray 80 and the toner cartridge 70 as the replacement target supported by the tray 80 protrude to the outside of the apparatus main body 1A through the opening 16a.

More specifically, the tray 80 is movable to an accommodation position and an extraction position relative to the rotary main body 90. The accommodation position is the position where the tray 80 is accommodated in the rotary main body 90. The extraction position is the position where the tray 80 protrudes to the outside of the rotary main body 90, and the toner cartridge 70 is to be extracted from the tray 80 (a detachment position or a replaceable position). Examples of the accommodation position are the positions of the trays 80y to 80k in FIGS. 4A and 4B. Examples of the extraction position are the positions of the tray 80 in FIGS. 6B and 6C, the tray 80k in FIG. 7A, and the tray 80m in FIG. 7B.

When the tray 80 is in the accommodation position, the toner cartridge 70 attached to the tray 80 is in the attachment position. When the tray 80 is in the extraction position, the toner cartridge 70 attached to the tray 80 is in the retraction position.

As illustrated in FIGS. 7A and 7B, the rotary main body 90 includes a protruding portion 95 that holds the tray 80 at the accommodation position and holds the toner cartridge 70 at the attachment position. As illustrated in FIG. 8, in the tray 80, a recessed portion 87 that is fitted to the protruding portion 95 is provided. Although FIGS. 7A and 7B illustrate protruding portions 95k and 95m corresponding to the trays 80k and 80m and FIG. 8 illustrates recessed portions 87y and 87m of the trays 80y and 80m, respectively, the protruding portion 95 and the recessed portion 87 are provided for each of the trays 80y to 80k. It is desirable that the protruding portion 95 be biased in the direction of being engaged with the recessed portion 87.

The protruding portion 95 is fitted to the recessed portion 87 of the tray 80, whereby the tray 80 is locked to the rotary frame 90f. Consequently, even in rotation of the rotary main body 90, the tray 80 stays at the accommodation position, and the toner cartridge 70 is prevented from moving from the attachment position. A configuration may be employed in which in a case where the tray 80 is moved between the accommodation position and the extraction position by the movement device 85, the protruding portion 95 is moved by the tray 80, and the protruding portion 95 comes off the recessed portion 87.

In the present exemplary embodiment, the door 14 is supported pivotably relative to the apparatus main body 1A. As illustrated in FIG. 7A, the door 14 is biased from the open position toward the closed position by a spring 14s. For example, the spring 14s is a tension spring and biases the door 14 to produce a moment in the counterclockwise direction in FIGS. 7A and 7B about a spindle 14c of the door 14.

The tray 80 presses the door 14, whereby the door 14 enters the open state (the state in FIG. 6B). This state is also referred to as the state in which the tray 80 is supported by the door 14. The door 14 supports at least a part of the tray 80 protruding to the outside of the apparatus main body 1A, whereby it is possible to support the toner cartridge 70 more stably. In other words, when the first toner cartridge (the toner cartridge 70k) is in the first retraction position, the opening/closing member (the door 14) at the open position supports the first supporting member (the tray 80k). When the second toner cartridge (each of the toner cartridges 70y to 70c) is in the second retraction position, the opening/closing member (the door 14) at the open position supports the second supporting member (each of the trays 80y to 80c).

The door 14 is configured to abut a part of the frame 16 of the apparatus main body 1A (e.g., a lower edge 16c of the opening 16a) at the open position and not to pivot downward beyond the open position. In response to the tray 80 being pulled back from outside to inside the apparatus main body 1A, the door 14 returns to the closed position by the biasing force of the spring 14s.

The toner cartridge 70 is detachably held by the tray 80. Thus, as illustrated in FIG. 6C, the user can perform the work of detaching the toner cartridge 70 from the tray 80 and attaching a new toner cartridge 70 (the work for replacement of the toner cartridge 70). In a case where a plurality of toner cartridges 70 is replaced, the user can perform the work for replacement of the plurality of toner cartridges 70 by repeating the above operation.

FIGS. 7A and 7B illustrate cross sections of the periphery of the rotary main body 90 in replacement of the toner cartridge 70.

FIG. 7A illustrates the state in which the toner cartridge 70k for black is replaced. FIG. 7B illustrates the state in which the toner cartridge 70m for magenta is replaced.

The image forming apparatus 1 includes the movement device 85 (FIG. 8) that moves the toner cartridge 70 from the attachment position to the retraction position. In the present exemplary embodiment, the movement device 85 may be considered as a device including the tray 80. The movement device 85k including the tray 80k may be an example of a first movement device including the first supporting member. The movement device 85m including the tray 80m may be an example of a second movement device including the second supporting member.

Also in the state in which the toner cartridge 70 is in the retraction position, the tray 80 is in the state of being joined to the rotary main body 90 (the state of being supported by the rotary main body 90). To easily perform the operation of detaching the toner cartridge 70 from the rotary main body 90, it is desirable that the length by which the toner cartridge 70 protrudes from the rotary main body 90 at the retraction position be long. Since the toner cartridge 70 is configured to be attachable to and detachable from the rotary main body 90 through the tray 80, even in a case where the length by which the toner cartridge 70 protrudes from the rotary main body 90 is long, the tray 80 stably supports the toner cartridge 70.

The moving direction of the toner cartridge 70 when the toner cartridge 70 moves from the attachment position to the retraction position is referred to as a “retraction direction”. In the present exemplary embodiment, the retraction direction of the toner cartridge 70 is a direction intersecting the direction of the rotational axis 90C (the Y-direction). Thus, as illustrated in FIGS. 7A and 7B, when viewed in the direction of the rotational axis 90C (the Y-direction), the retraction direction of the toner cartridge 70 is a direction orthogonal to the direction of the rotational axis 90C (the Y-direction). The retraction direction of the toner cartridge 70 is also referred to as a direction outward in the radial direction of the rotation of the rotary main body 90 (a direction away from the rotational axis 90C).

Since the user performs the operation of detaching the toner cartridge 70 from the rotary main body 90 as illustrated in FIGS. 7A and 7B, it is desirable that in detachment of the toner cartridge 70, at least a part of the toner cartridge 70 protrude from the rotary main body 90. In the present exemplary embodiment, when the toner cartridge 70 is in the retraction position, the entirety of the toner cartridge 70 protrudes from the rotary main body 90.

In other words, when the rotary main body 90 rotates about the rotational axis 90C, the rotational trajectory of the rotary main body 90 coincides with the circumcircle of the rotary main body 90 centered at the rotational axis 90C (a virtual circle 90V indicated by a dashed line in each of FIGS. 7A and 7B). It is desirable that when the toner cartridge 70 is in the retraction position, half or more of the length of the toner cartridge 70 with respect to the retraction direction be outside the rotational trajectory of the rotary main body 90. That is, it is desirable that when viewed in the rotational axis direction of the rotary, and in the state in which the toner cartridge 70 is in the retraction position, half or more of the entire length of the toner cartridge 70 with respect to the moving direction of the toner cartridge 70 from the attachment position toward the retraction position be set outside the rotational trajectory of the rotary. This applies to all the toner cartridges 70 including the toner cartridge 70k as an example of the first cartridge and the toner cartridge 70m as an example of the second cartridge. In the present exemplary embodiment, as illustrated in FIGS. 7A and 7B, when the toner cartridge 70 is in the retraction position, the entirety of the toner cartridge 70 is outside the rotational trajectory (the virtual circle 90V) of the rotary main body 90.

Further, to make it easy for the user to grab the toner cartridge 70, it is desirable that when the toner cartridge 70 is in the retraction position, at least a part of the toner cartridge 70 be outside the apparatus of the image forming apparatus 1 (outside the apparatus of the apparatus main body 1A). “Outside the apparatus” refers to a space outside the image forming apparatus 1 (outside the apparatus main body 1A) in use of the image forming apparatus 1, for example, to perform the image forming operation on a sheet S.

In the present exemplary embodiment, exterior surfaces of the apparatus main body 1A are formed by exterior surfaces of the frame 16. That is, “outside the apparatus” is also referred to as a space outside the frame 16. Thus, the state in which at least a part of the toner cartridge 70 is outside the apparatus is also referred to as the state in which at least a part of the toner cartridge 70 protrudes from the opening 16a of the frame 16 of the apparatus main body 1A toward the outside of the frame 16.

In the present exemplary embodiment, when the door 14 is in the closed position, the opening 16a of the frame 16 of the apparatus main body 1A is covered by the door 14. Then, a part of an exterior surface of the apparatus main body 1A is formed by an exterior surface 14a of the door 14 at the closed position. In this case, “outside the apparatus” refers to a space outside the exterior surface 14a of the door 14 at the closed position. That is, in a case where the position of the exterior surface 14a of the door 14 at the closed position is defined as an exterior position, and the toner cartridge 70 is in the retraction position, at least a part of the toner cartridge 70 is set further outside the apparatus main body 1A than the exterior position.

In other words, in a case where the door 14 is in the closed position, at least a part of the toner cartridge 70 is set in a space outside the apparatus main body 1A. Then, at least a part of the toner cartridge 70 with respect to the retraction direction of the toner cartridge 70 is in a position downstream of the exterior position.

In a case where the side surface 16b in which the opening 16a is provided is defined as the front surface of the apparatus main body 1A, and when the toner cartridge 70 is in the retraction position, at least a part of the toner cartridge 70 protrudes further to the front surface than the exterior surface on the front surface of the apparatus main body 1A. In this case, the user can easily perform the work for replacement of the toner cartridge 70 by accessing the toner cartridge 70 from the front surface of the image forming apparatus 1.

It is desirable that when the toner cartridge 70 is in the retraction position, half or more of the length of the toner cartridge 70 with respect to the retraction direction be outside the apparatus. That is, it is desirable that when viewed in the rotational axis direction of the rotary, and in the state in which the toner cartridge 70 is in the retraction position, half or more of the entire length of the toner cartridge 70 with respect to the moving direction of the toner cartridge 70 from the attachment position toward the retraction position be set outside the main body frame. This applies to all the toner cartridges 70 including the toner cartridge 70k as an example of the first cartridge and the toner cartridge 70m as an example of the second cartridge. It is more desirable that when the toner cartridge 70 is in the retraction position, the entirety of the toner cartridge 70 be outside the apparatus. Although in the present exemplary embodiment, the exterior surface on the front surface of the apparatus main body 1A is formed by the exterior surface 14a of the door 14 and the side surface 16b, the configuration of the door 14 is not limited to this. For example, the size of the door 14 may be a size that covers the entirety of the side surface 16b. In this case, the exterior surface on the front surface of the apparatus main body 1A is formed by the exterior surface 14a of the door 14.

The tray 80 includes a cartridge holding portion 81 that holds the toner cartridge 70 (see FIGS. 3 and 6C). The cartridge holding portion 81 is an attachment target portion to which the toner cartridge 70 is attached. It is desirable that when the tray 80 is in the extraction position, the entirety of the cartridge holding portion 81 with respect to the retraction direction be outside the rotational trajectory of the rotary main body 90. It is desirable that when the tray 80 is in the extraction position, half or more of the length of the cartridge holding portion 81 with respect to the retraction direction be outside the apparatus.

As described above, the toner cartridge 70k and the tray 80k have sizes more than those of the other toner cartridges 70y to 70c and the other trays 80y to 80c. Thus, as illustrated in FIGS. 7A and 7B, in the present exemplary embodiment, the moving amount of the tray 80 in replacement of the toner cartridge 70 is changed according to the size of the toner cartridge 70.

Specifically, as illustrated in FIG. 7A, the moving distance of the tray 80k when the tray 80k (the first supporting member) moves from the accommodation position (a first accommodation position) to the extraction position (a first extraction position) is L1. The moving distance of the tray 80m when the tray 80m (the second supporting member) moves from the accommodation position to the extraction position (a third extraction position) is L2. Although FIG. 7B illustrates the state in which the toner cartridge 70m and the tray 80m are moved, the moving distance of each of the trays 80y and 80c when the tray moves from the accommodation position to the extraction position is also L2. At this time, L1 is longer than L2. In other words, the moving distance of the first supporting member when the first toner cartridge moves from the first attachment position to the first retraction position is longer than the moving distance of the second supporting member when the second toner cartridge moves from the second attachment position to the second retraction position.

As illustrated in FIG. 7A, in the state in which the tray 80k is in the extraction position and the toner cartridge 70k is in the retraction position, the toner cartridge 70k protrudes from the exterior surface of the apparatus main body 1A to the outside of the apparatus by a distance P1. In the present exemplary embodiment, the tray 80k also protrudes from the exterior surface of the apparatus main body 1A to the outside of the apparatus by the distance P1.

As illustrated in FIG. 7B, in the state in which the tray 80m is in the extraction position and the toner cartridge 70m is in the retraction position, the toner cartridge 70m protrudes from the exterior surface of the apparatus main body 1A to the outside of the apparatus by a distance P2. In the present exemplary embodiment, the tray 80m also protrudes from the exterior surface of the apparatus main body 1A to the outside of the apparatus by the distance P2. The toner cartridges 70y and 70c also protrude from the exterior surface of the apparatus main body 1A to the outside of the apparatus by the distance P2.

The distance P1 is longer than the distance P2. That is, the length by which the first toner cartridge at the first retraction position protrudes from the opening 16a of the apparatus main body 1A is a first length (P1), and the length by which the second toner cartridge at the second retraction position protrudes from the opening 16a is a second length (P2). In this case, the first length is longer than the second length.

It is desirable that the distance P2 by which each of the toner cartridges 70y to 70c having sizes less than that of the toner cartridge 70k protrudes to the outside of the apparatus at the retraction position should be less than the distance P1 by which the toner cartridge 70k protrudes to the outside of the apparatus at the retraction position in terms of strength. The reason is as follows. When the toner cartridge 70 is in the retraction position, at least a part of the toner cartridge 70 protrudes to the outside of the rotational trajectory of the rotary main body 90 or protrudes from the exterior surface of the apparatus main body 1A to the outside of the apparatus. At this time, the tray 80 supports the weight of the toner cartridge 70 in the state in which the tray 80 is supported in a cantilever manner by the rotary main body 90. Thus, it is possible to reduce loads applied to the trays 80y to 80c and a guide portion 97 of the rotary main body 90 that supports each of the trays 80y to 80k more by shortening the distance P2 by which each of the toner cartridges 70y to 70c protrudes to the outside of the apparatus at the retraction position. Since the toner cartridges 70y to 70c have sizes less than that of the toner cartridge 70k, it is possible to maintain the workability in replacement of the toner cartridges 70y to 70c in the trays 80y to 80c, respectively, even with the distance P2 shorter than the distance P1.

### (Placement of Trays in Rotary)

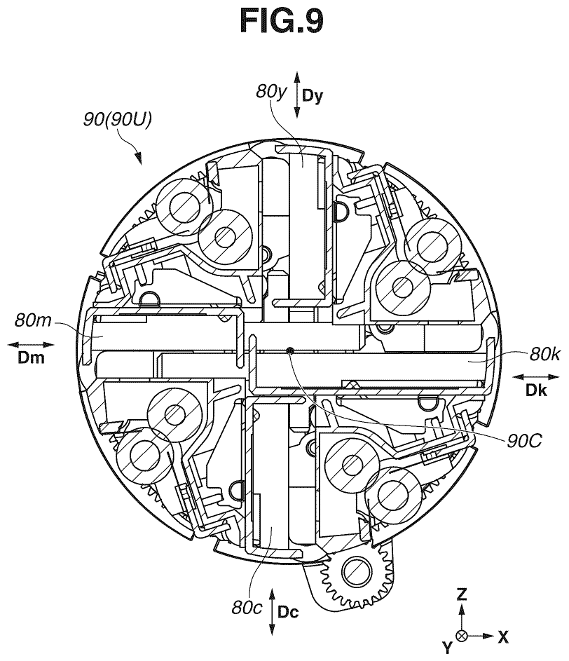

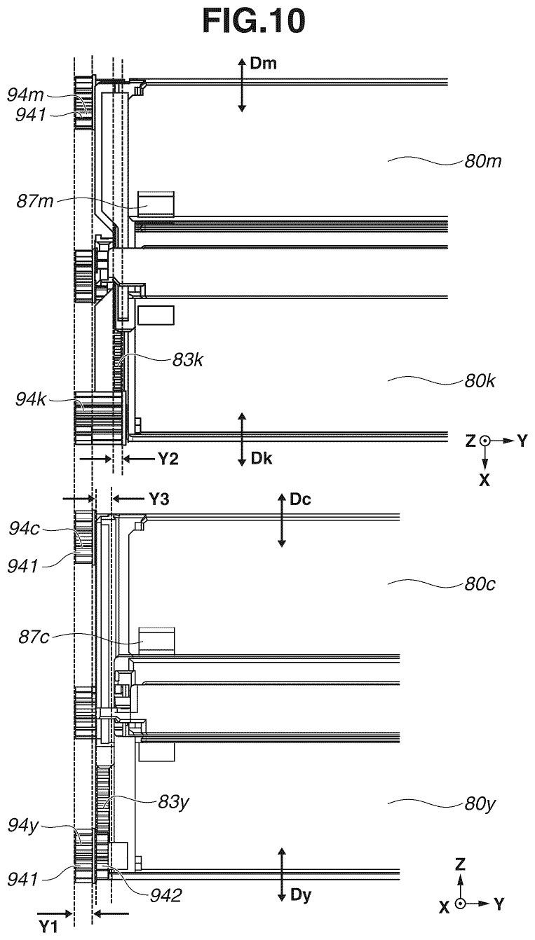

With reference to FIGS. 8, 9, and 10, the placement of the trays 80y to 80k in the rotary main body 90 is described. FIG. 8 is a perspective view illustrating the placement of the trays 80y to 80k in the rotary main body 90. FIG. 9 is a cross-sectional view illustrating the placement of the trays 80y to 80k in the rotary main body 90. FIG. 10 is a diagram illustrating the placement of members on one end sides in the Y-direction of the trays 80y to 80k. FIG. 9 illustrates a cross section of the rotary main body 90 along a virtual plane perpendicular to the rotational axis 90C of the rotary main body 90. The upper half portion of FIG. 10 is a view of the rotary main body 90 and the trays 80m and 80k in FIG. 8 from the upper right side (the positive Z-side) in FIG. 8. The lower half portion of FIG. 10 is a view of the rotary main body 90 and the trays 80c and 80y in FIG. 8 from the left side (the negative X-side) in FIG. 8.

As illustrated in FIG. 8, in the trays 80y to 80k, the cartridge holding portions 81y to 81k and guide target portions 82y to 82k are provided, respectively.

The toner cartridges 70y to 70k are attached to the cartridge holding portions 81y to 81k, respectively. The cartridge holding portions 81y to 81k accommodate at least parts of the toner cartridges 70y to 70k attached to the cartridge holding portions 81y to 81k, respectively.

The guide target portions 82y to 82k are provided in both end portions of the trays 80y to 80k across the cartridge holding portions 81y to 81k in the Y-direction, respectively. Each of the guide target portions 82y to 82k is a member extending long and narrow in a direction orthogonal to the rotational axis of the rotary main body 90.

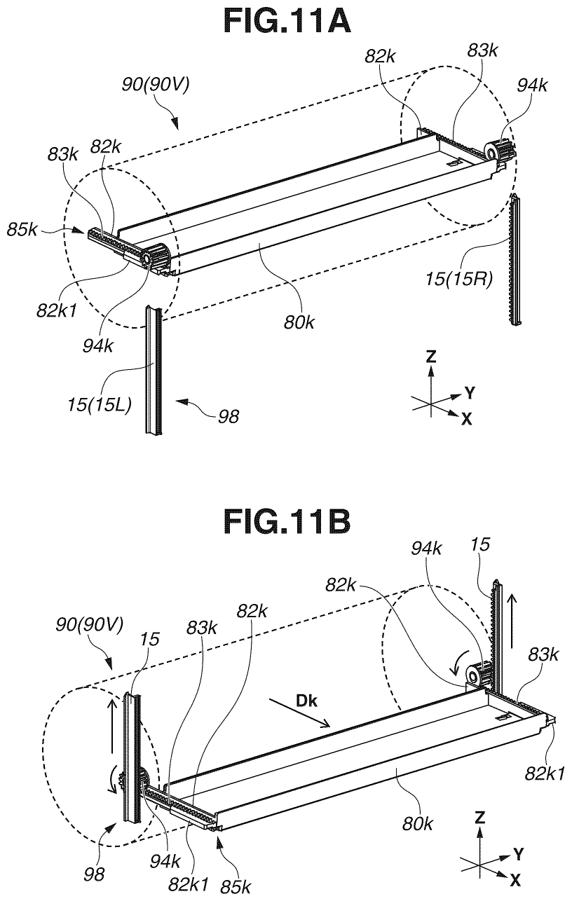

In the present exemplary embodiment, in a part of the guide target portion 82k in a moving direction Dk of the tray 80k, a reinforcement rib 82k1 is formed. In a part of the guide target portion 82m in a moving direction Dm of the tray 80m, a reinforcement rib 82m1 is formed (see also FIGS. 11A and 11B). The reinforcement ribs 82k1 and 82m1 have rib shapes (ribbed protrusion) protruding outward in the Y-direction from the guide target portions 82k and 82m provided in both end portions of the trays 80k and 80m in the Y-direction and extending long and narrow in the moving directions Dk and Dm of the trays 80k and 80m, respectively. The reinforcement ribs 82k1 and 82m1 improve the stiffness of the guide target portions 82k and 82m, respectively.

In the present exemplary embodiment, the lengths of the reinforcement ribs 82m1 and 82kl are limited by avoiding the guide target portions 82y and 82c, respectively. However, in a case where the reinforcement ribs 82m1 and 82k1 do not interfere with the guide target portions 82y and 82c, the reinforcement ribs 82m1 and 82k1 may be provided over the entire lengths of the guide target portions 82m and 82k, respectively. Reinforcement ribs may be added to the guide target portions 82y and 82c. In a case where the stiffness of the guide target portions 82m and 82k is sufficient, a configuration may be employed in which the reinforcement ribs 82m1 and 82kl are not provided, respectively.

In the guide target portions 82y to 82k, rack portions 83y to 83k (rack gears) are formed, respectively. In the rotary main body 90, pinion gears 94y to 94k are rotatably held. The pinion gears 94y to 94k mesh with the rack portions 83y to 83k so that the pinion gears 94y to 94k transmit drive to the rack portions 83y to 83k, respectively.

The rack portions 83y to 83k and the pinion gears 94y to 94k are parts of the movement devices 85y to 85k configured to move the toner cartridges 70y to 70k from the attachment positions to the retraction positions, respectively. The rack portions 83y to 83k and the pinion gears 94y to 94k are also referred to as parts of driving target devices that are driven by the driving device 98 of the apparatus main body 1A.

The pinion gears 94y to 94k are also referred to as rotating bodies (rotating members) that move the trays 80y to 80k, respectively, relative to the rotary main body 90 by rotating.

The pinion gears 94y to 94k and the rack portions 83y to 83k function as driving target portions for the movement devices 85y to 85k, respectively, of the rotary main body 90 to receive a driving force from the driving device 98 of the apparatus main body 1A. The pinion gear 94k and the rack portion 83k are examples of a first pinion gear and a first rack gear, respectively, that constitute at least a part of a first driving target portion included in the first movement device. The pinion gear 94m and the rack portion 83m are examples of a second pinion gear and a second rack gear, respectively, that constitute at least a part of a second driving target portion included in the second movement device.

The rotary main body 90 includes the guide portion 97 (see FIGS. 7A and 7B) that is engaged with each of the guide target portions 82y to 82k. FIG. 7A illustrates the guide portion 97 (97k) that is engaged with the guide target portion 82k of the tray 80k. FIG. 7B illustrates the guide portion 97 (97m) that is engaged with the guide target portion 82m of the tray 80m. In the rotary main body 90, similar guide portions 97 that are engaged with the guide target portions 82y and 82c of the trays 80y and 80c are provided, respectively. Although each of FIGS. 7A and 7B illustrates the guide portion 97 provided on one side (the positive Y-side) of the rotary main body 90 in the Y-direction, a similar guide portion 97 is also provided on the other side (the negative Y-side) of the rotary main body 90 in the Y-direction.

When the tray 80 moves between the accommodation position and the extraction position, the guide portion 97 maintains the state of being engaged with the guide target portion 82 in at least a part of the moving range of the tray 80 and guides the moving direction of the tray 80. In the present exemplary embodiment, in the entirety of the moving range between the accommodation position and the extraction position of the tray 80k, the guide portion 97k maintains the state of being engaged with the guide target portion 82k. In the present exemplary embodiment, in the entirety of the moving range between the accommodation position and the extraction position of the tray 80m, the guide portion 97m maintains the state of being engaged with the guide target portion 82m.

As illustrated in FIGS. 8 and 9, in the rotary main body 90, the four trays 80y to 80k are placed to overlap each other as specifically described below.

In response to rotation of the pinion gears 94y to 94k, the rack portions 83y to 83k and the trays 80y to 80k, respectively, move relative to the rotary main body 90. As illustrated in FIG. 9, the four trays 80y to 80k are placed so that the moving directions of the four trays 80y to 80k are directions shifted from each other by 90 degrees relative to the rotary main body 90. Thus, the trays 80y and 80c are held to be movable in a sliding manner in substantially the same direction as each other (parallel directions to each other), and the trays 80m and 80k are held to be movable in a sliding manner in substantially the same direction as each other (parallel directions to each other). The moving directions of the trays 80y to 80k when the trays 80y to 80k move in a sliding manner as described above are limited by the engagement between each of the guide target portions 82y to 82k and the guide portion 97.

The trays 80y to 80k move to outside the apparatus through the opening 16a. When each of the trays 80y to 80k moves from the opening 16a to outside the apparatus, the moving directions of the trays 80y to 80k are substantially the same direction as each other (parallel to each other).

As illustrated in FIG. 9, with respect to the moving direction Dk of the tray 80k, the range where the tray 80k is placed is placed to overlap the range where the tray 80y is placed and the range where the tray 80c is placed. With respect to the moving direction Dk of the tray 80k, the range where the tray 80k is placed overlaps the rotational axis 90C of the rotary main body 90. That is, the toner cartridge 70k held in the cartridge holding portion 81k of the tray 80k overlaps the rotational axis 90C of the rotary main body 90 (FIG. 4B).

On the other hand, with respect to the moving direction Dm of the tray 80m, the range where the tray 80m is placed is placed in a shifted manner so as not to overlap the range where the tray 80y is placed and the range where the tray 80c is placed. Further, with respect to the moving direction Dy of the tray 80y, the range where the tray 80y is placed is placed in a shifted manner so as not to overlap the range where the tray 80m is placed and the range where the tray 80k is placed. Similarly, with respect to the moving direction Dc of the tray 80c, the range where the tray 80c is placed is placed in a shifted manner so as not to overlap the range where the tray 80m is placed and the range where the tray 80k is placed.

The positional relationships between the trays 80 are also represented as follows. When viewed in the moving direction Dy of the tray 80y, the trays 80y and 80k overlap each other, but the trays 80y and 80m do not overlap each other. When viewed in the moving direction Dm of the tray 80m, the trays 80m and 80k overlap each other, but the tray 80m and the trays 80y and 80c do not overlap each other. When viewed in the moving direction Dc of the tray 80c, the trays 80c and 80k overlap each other, but the trays 80c and 80m do not overlap each other.

That two components (members, parts, or units) overlap each other when viewed in a particular direction means that in a case where each component is projected perpendicular to a virtual plane perpendicular to the particular direction, a projection region of one of the components and a projection region of the other component at least partially overlap each other.

As illustrated in FIGS. 8 and 10, with respect to the direction of the rotational axis 90C (the Y-direction), the range where the rack portion 83m and the guide target portion 82m are placed and the range where the rack portion 83k and the guide target portion 82k are placed at least partially overlap each other. That is, in the present exemplary embodiment, with respect to the rotational axis direction of the rotary (the Y-direction), the range where the first rack gear (the rack portion 83k) is placed and the range where the second rack gear (the rack portion 83m) is placed at least partially overlap each other. Thus, it is possible to place the rack portions 83m and 83k and the guide target portions 82m and 82k with respect to the Y-direction by saving more space than in placement in which the rack portion 83m and the guide target portion 82m and the rack portion 83k and the guide target portion 82k do not overlap each other.

With respect to the direction of the rotational axis 90C (the Y-direction), the range where the rack portion 83y and the guide target portion 82y are placed and the range where the rack portion 83c and the guide target portion 82c are placed at least partially overlap each other. That is, in the present exemplary embodiment, with respect to the rotational axis direction of the rotary (the Y-direction), the range where a third rack gear (the rack portion 83y) is placed and the range where a fourth rack gear (the rack portion 83c) is placed at least partially overlap each other. Thus, it is possible to place the rack portions 83y and 83c and the guide target portions 82y and 82c with respect to the Y-direction by saving more space than in placement in which the rack portion 83y and the guide target portion 82y and the rack portion 83c and the guide target portion 82c do not overlap each other.

With reference to FIG. 10, the meshing position of the rack portion 83 and the pinion gear 94 is described. The upper half portion of FIG. 10 illustrates the meshing position of the rack portion 83k and the pinion gear 94k. The lower half portion of FIG. 10 illustrates the meshing position of the rack portion 83y and the pinion gear 94y.

With respect to the direction of the rotational axis 90C of the rotary main body 90 (the Y-direction), in a region Y1 in FIG. 10, the driving force transmitted from the motor M2 (FIG. 2) as a driving source by the transmission device is transmitted to the pinion gears 94y to 94k. With respect to the Y-direction, in a region Y2 in FIG. 10, the pinion gear 94k meshes with the rack portion 83k so that the pinion gear 94k transmits drive to the rack portion 83k. With respect to the Y-direction, in a region Y3 in FIG. 10. the pinion gear 94y meshes with the rack portion 83y so that the pinion gear 94y transmits drive to the rack portion 83y. Similarly to the rack portion 83k, in the region Y2, the rack portion 83m meshes with the pinion gear 94m (FIG. 8) so that the pinion gear 94m transmits drive to the rack portion 83m. Similarly to the rack portion 83y, in the region Y3, the rack portion 83c meshes with the pinion gear 94c (FIG. 8) so that the pinion gear 94c transmits drive to the rack portion 83c.

The regions Y2 and Y3 are in different positions in the Y-direction (shifted in the Y-direction) from each other. The region Y1 is in a different position in the Y-direction from the regions Y2 and Y3. That is, the region Y1 is shifted in the Y-direction from the regions Y2 and Y3.

Further, in the state in which the toner cartridges 70y and 70c are in the attachment positions, with respect to the moving direction of the rack portion 83y (the moving direction Dy of the tray 80y), the range where the rack portion 83y is placed and the range where the rack portion 83c is placed at least partially overlap each other. In the present exemplary embodiment, since the moving directions Dy and Dc of the trays 80y and 80c, respectively, are substantially the same direction as each other (parallel to each other), also with respect to the moving direction Dc of the tray 80c, the range where the rack portion 83y is placed and the range where the rack portion 83c is placed at least partially overlap each other. Thus, in the state in which the toner cartridges 70y and 70c are in the attachment positions, with respect to a direction orthogonal to the moving directions Dy and Dc of the rack portions 83y and 83c, respectively (the left-right direction in FIG. 8), the tooth surface of the rack portion 83y and the tooth surface of the rack portion 83c are opposed to each other.

Further, in the state in which the toner cartridges 70m and 70k are in the attachment positions, with respect to the moving direction of the rack portion 83m (the moving direction Dm of the tray 80m), the range where the rack portion 83m is placed and the range where the rack portion 83k is placed at least partially overlap each other. In the present exemplary embodiment, since the moving directions Dm and Dk of the trays 80m and 80k, respectively, are substantially the same direction as each other (parallel to each other), also with respect to the moving direction Dk of the tray 80k, the range where the rack portion 83m is placed and the range where the rack portion 83k is placed at least partially overlap each other. Thus, in the state in which the toner cartridges 70m and 70k are in the attachment positions, with respect to a direction orthogonal to the moving directions Dm and Dk of the rack portions 83m and 83k, respectively (the up-down direction in FIG. 8), the tooth surface of the rack portion 83m and the tooth surface of the rack portion 83k are opposed to each other.

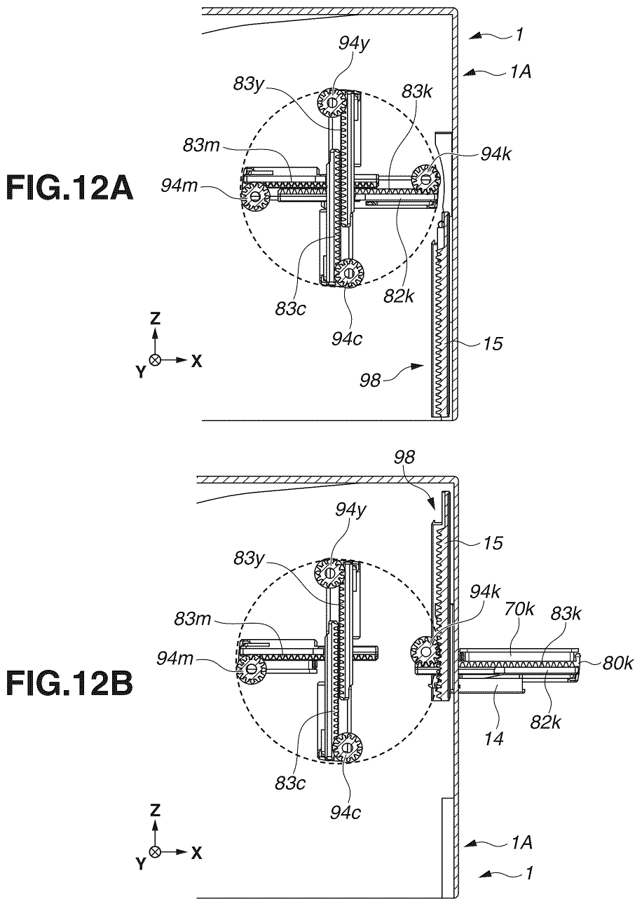

Also as illustrated in FIG. 12A, when viewed in the direction of the rotational axis 90C (the Y-direction), the rack portion 83y overlaps the rack portions 83m and 83k. When viewed in the direction of the rotational axis 90C (the Y-direction), the rack portion 83m overlaps the rack portions 83y and 83c. When viewed in the direction of the rotational axis 90C (the Y-direction), the rack portion 83c overlaps the rack portions 83m and 83k. When viewed in the direction of the rotational axis 90C (the Y-direction), the rack portion 83k overlaps the rack portions 83y and 83c. In other words, with respect to the rotational axis direction of the rotary (the Y-direction), the range where the first rack gear (the rack portion 83k) is placed and the range where the second rack gear (the rack portion 83y) is placed do not overlap each other. In other words, when viewed in the rotational axis direction of the rotary (the Y-direction), in the state in which the first toner cartridge 70k is in the first attachment position and the second toner cartridge 70y is in the second attachment position, the first rack gear (the rack portion 83k) and the second rack gear (the rack portion 83y) overlap each other.

As described above, with respect to the Y-direction, the positions where the rack portions 83k and 83m are placed and the positions where the rack portions 83y and 83c are placed are different from each other, and therefore, it is possible to place the rack portions 83y and 83c and the rack portions 83m and 83k to overlap each other when viewed in the Y-direction.

Consequently, it is possible to save space for placing the four trays 80y to 80k in the rotary main body 90 and achieve the miniaturization of the rotary main body 90 in the radial direction of the rotation of the rotary main body 90. That is, if rack portions 83 are placed without overlapping each other when viewed in the Y-direction while making the moving distances of the trays 80y to 80k equivalent to those in the present exemplary embodiment, the area required to place the four rack portions 83y to 83k when viewed in the Y-direction becomes wide. A plurality of rack portions 83 is placed by shifting the positions in the Y-direction of the plurality of rack portions 83, and the rack portions 83 overlap each other when viewed in the Y-direction, whereby it is possible to make the placement areas of the rack portions 83 when viewed in the Y-direction less than in such a configuration.

In the present exemplary embodiment, the four rack portions 83y to 83k are placed by forming two sets of two of the four rack portions 83y to 83k and shifting the positions of the two sets in the Y-direction from each other. That is, with respect to the rotational axis direction of the rotary (the Y-direction), the ranges where the first and second rack gears are placed overlap each other, and the ranges where the third and fourth rack gears are placed overlap each other. Further, with respect to the Y-direction, the ranges where the first and second rack gears are placed and the ranges where the third and fourth rack gears are placed are placed so as not to overlap each other. Consequently, it is possible to miniaturize the rotary main body 90 in the Y-direction compared to a case where the position of each of the four rack portions 83y to 83k is shifted in the Y-direction.

### (Movement Configuration of Trays)

With reference to FIGS. 11A, 11B, 12A, and 12B, configurations regarding the movements of the trays 80y to 80k placed in the rotary main body 90 are described. FIGS. 11A and 11B are perspective views illustrating the configuration regarding the movement of the tray 80k. FIGS. 12A and 12B are cross-sectional views illustrating the configuration regarding the movement of the tray 80k.

In the present exemplary embodiment, all the trays 80y to 80k are driven by the driving racks 15L and 15R as the transmission device transmitting the driving force of the motor M2 to the pinion gears 94y to 94k, respectively. A description is given of a configuration in which the tray 80k is moved relative to the rotary main body 90. Configurations in which the trays 80y to 80c are moved relative to the rotary main body 90 are substantially similar to the configuration in which the tray 80k is moved, and therefore are not described.

FIG. 11A illustrates the state in which the tray 80k is inside the rotary main body 90 (i.e., the state in which the toner cartridge 70k is attached to the development unit 50k). That is, FIG. 11A illustrates the state in which the tray 80k is in the accommodation position, and corresponds to the state in which the toner cartridge 70k is in the attachment position relative to the development frame 53k (FIG. 4A). FIG. 11B illustrates the state in which the tray 80k is moved in a sliding manner to outside the rotary main body 90. That is, FIG. 11B illustrates the state in which the tray 80k is in the extraction position, and corresponds to the state in which the toner cartridge 70k is in the retraction position relative to the development frame 53k (FIG. 4B).

The apparatus main body 1A according to the present exemplary embodiment includes the driving racks 15L and 15R as driving gears that drive the pinion gear 94. Each driving rack 15 is driven by the motor M2 through a drive transmission mechanism (not illustrated).

As described above, two rack portions 83k are formed in both end portions of the tray 80k in the Y-direction. Two pinion gears 94k, two driving racks 15L, and two driving racks 15R are placed at positions corresponding to the rack portions 83k in both end portions. That is, the apparatus main body 1A according to the present exemplary embodiment includes the driving racks 15L and 15R as a first driving gear and a second driving gear, respectively. The driving rack 15L is an example of the first driving gear, and the driving rack 15R is an example of the second driving gear.

However, this numbering is merely used for descriptive purposes, and the numbers may be appropriately switched as a rule. In a case where the driving racks 15L and 15R do not need to be distinguished from each other, the driving racks 15L and 15R are referred to as the “driving rack 15”.

The rack portion 83 according to the present exemplary embodiment is configured as a rack gear pair, and the pinion gear 94 according to the present exemplary embodiment is configured as a pinion gear pair. In the present exemplary embodiment, the rack gear pair and the pinion gear pair are placed on one end and the other end of the supporting member (the tray 80) in the Y-direction, but may be placed at other positions. The rack portion 83k of the movement device 85k and the pinion gear 94k corresponding to the tray 80k are examples of a first rack gear pair and a first pinion gear pair, respectively.

The rack portions 83y to 83c of the movement devices 85y to 85c and the pinion gears 94y to 94c corresponding to the other trays 80y to 80c are examples of a second rack gear pair and a second pinion gear pair, respectively.

One rack gear of the rack gear pair meshes with one pinion gear of the pinion gear pair, and the other rack gear of the rack gear pair meshes with the other pinion gear of the pinion gear pair. At least one pinion gear of the pinion gear pair is driven by the driving rack 15L as a first driving rack. In the present exemplary embodiment, both pinion gears of the pinion gear pair are simultaneously driven by the driving racks 15L and 15R as the first driving rack and a second driving rack, respectively. Consequently, the rotation of the tray 80 is less likely to occur, and the toner cartridge 70 stably moves.

A configuration may be employed in which the tray 80 includes a single rack portion 83 and is moved by a single driving rack 15 through a single pinion gear 94.

The tray 80k is held to be movable in a sliding manner in a direction parallel to the guide target portion 82k (i.e., the moving direction Dk) relative to the rotary main body 90. The driving rack 15 is held to be movable in a sliding manner in a direction intersecting the moving direction Dk of the tray 80k relative to the apparatus main body 1A. The driving rack 15 is configured to move in a sliding manner (in a reciprocating manner) in a first direction (upward in the vertical direction in the present exemplary embodiment) and a second direction (downward in the vertical direction in the present exemplary embodiment) opposite to the first direction, relative to the apparatus main body 1A. That is, the moving direction of the driving rack 15 according to the present exemplary embodiment is a direction intersecting (desirably a direction orthogonal to) both the moving direction Dk of the tray 80k and the direction of the rotational axis 90C of the rotary main body 90 (the Y-direction).

With reference to FIGS. 11A and 11B, tray movement operations for moving the tray 80k in a sliding manner between the accommodation position and the extraction position are described. The tray movement operations for moving the tray 80k are performed by the motor M2 (FIG. 2), the drive transmission mechanism (not illustrated), the driving rack 15, the pinion gear 94k, and the rack portion 83k.

First, a description is given of a tray movement operation (a tray pull-out operation) in detachment of the toner cartridge 70k from the rotary main body 90. In the state before the tray pull-out operation is started, the driving rack 15 is in a position below the position where the driving rack 15 meshes with the pinion gear 94k (FIG. 11A). As described above, in the replacement operation for replacement of the toner cartridge 70k, the rotary main body 90 is in the replacement posture (FIG. 4B) for replacement the toner cartridge 70k.

In response to a start of the tray pull-out operation, the driving rack 15 is moved in a sliding manner in the up direction of the apparatus main body 1A by the driving force of the motor M2. The driving rack 15 meshes with the pinion gear 94k in the process of moving, and the pinion gear 94k is rotationally driven.

As illustrated in FIG. 11B, the pinion gear 94k is rotationally driven in the direction of an arrow in FIG. 11B, whereby the driving force is input to the rack portion 83k meshing with the pinion gear 94k. Consequently, the tray 80k is pushed out of the apparatus and moves from the accommodation position to the extraction position relative to the rotary main body 90. The moving direction of the tray 80k at this time is guided in the predetermined moving direction Dk by the engagement between the guide target portion 82k and the guide portion 97k (FIG. 7A) of the rotary main body 90. As a result of the movement of the tray 80k from the accommodation position to the extraction position, the toner cartridge 70k is moved from the attachment position to the retraction position relative to the development unit 50k.

In the state in which the tray 80k is in the extraction position and the toner cartridge 70k is in the retraction position, the user can attach and detach the toner cartridge 70k to and from the tray 80k.

A tray movement operation (a tray pull-in operation or a tray insertion operation) in attachment of the toner cartridge 70 to the rotary main body 90 is performed by a process opposite to that of the tray pull-out operation. In the state before the tray pull-in operation is started, the driving rack 15 is in a position above the position where the driving rack 15 meshes with the pinion gear 94k. For example, the tray pull-in operation is started by the user operating a predetermined operation section. In response to a start of the tray pull-in operation, the driving rack 15 is moved in a sliding manner in the down direction of the apparatus main body 1A by the driving force of the motor M2. The rotational direction of the motor M2 in the tray pull-in operation is a direction opposite to that in the tray pull-out operation. The driving rack 15 meshes with the pinion gear 94k in the process of moving, and the pinion gear 94k is rotationally driven.

The pinion gear 94k is rotationally driven in a direction opposite to that of the arrow in FIG. 11B, whereby the driving force is input to the rack portion 83k meshing with the pinion gear 94k. Consequently, the tray 80k is pulled into the apparatus and moves from the extraction position to the accommodation position relative to the rotary main body 90.

The moving direction of the tray 80k is guided in the moving direction Dk (a direction opposite to that of an arrow in FIG. 11B) by the engagement between the guide target portion 82k and the guide portion 97k (FIG. 7A) of the rotary main body 90. As a result of the movement of the tray 80k from the extraction position to the accommodation position, the toner cartridge 70k is moved from the retraction position to the attachment position relative to the development unit 50k.

Although the movements of the tray 80k and the toner cartridge 70k for black have been described above, the movements of the other trays 80y to 80c and the other toner cartridges 70y to 70c are also made by a similar mechanism. That is, in the replacement postures for replacement of the respective toner cartridges 70y to 70c, the driving rack 15 transmits drive to the pinion gears 94y to 94c.

The driving device 98 that drives the movement device 85 provided in the rotary main body 90 is composed of the motor M2 and the transmission device including the driving rack 15 (15L and 15R) and the drive transmission mechanism that are provided in the apparatus main body 1A.

As described above, in the present exemplary embodiment, in the rotary main body 90, the plurality of movement devices 85k to 85y corresponding to the plurality of toner cartridges 70k to 70y is placed. The driving device 98 of the apparatus main body 1A is a common driving device that drives the plurality of movement devices 85k to 85y (the plurality of driving target devices) of the rotary main body 90.

In the present exemplary embodiment, the driving target of the driving device 98 switches by the rotation of the rotary main body 90. In other words, a driving device according to the present exemplary embodiment includes the driving rack 15 as a transmission member that transmits the driving force of a driving source. The driving device shifts to the state in which the transmission member is engaged with the first driving target portion (the pinion gear 94k) so the transmission member transmits drive to the first driving target portion, and the state in which the transmission member is engaged with the second driving target portion (the pinion gear 94m) so that the transmission member transmits drive to the second driving target portion. The driving device is also able to shift to the state in which the transmission member is separate from the first and second driving target portions.

As described above, the pinion gears 94y to 94k are held by the rotary main body 90. Thus, it is desirable that when the rotary main body 90 rotates, the meshing between the pinion gears 94y to 94k and the driving rack 15 be released.

FIG. 12A illustrates the state in which the tray 80k is inside the rotary main body 90 (the state in which the tray 80k is in the accommodation position). FIG. 12B illustrates the state in which the tray 80k is moved to outside the rotary main body 90 (the state in which the tray 80k is moved to the extraction position).

As illustrated in FIG. 12A, when the tray 80k is inside the rotary main body 90, the driving rack 15 is in a position in a lower portion of the apparatus main body 1A. At this time, the driving rack 15 is retracted from the pinion gear 94k. Thus, the driving rack 15 does not become an obstacle, and the rotary main body 90 is rotated. More specifically, the driving rack 15 is retracted to outside the rotational trajectory of the rotary main body 90 indicated by a dotted line in each of FIGS. 12A and 12B.

As described above, the motor M2 is rotationally driven in forward and backward directions, whereby it is possible to move the tray 80 attached to the rotary main body 90 from the extraction position to the accommodation position and from the accommodation position to the extraction position relative to the rotary main body 90. That is, the driving device according to the present exemplary embodiment not only drives each movement device of the rotary to move the toner cartridge from the attachment position to the retraction position, but also drives each movement device to move the toner cartridge from the retraction position to the attachment position.

As described above, in the present exemplary embodiment, the moving amount of the tray 80 in replacement of the toner cartridge 70 is changed according to the size of the toner cartridge 70. Specifically, as illustrated in FIGS. 7A and 7B, the moving distance L1 of the tray 80k for black when the tray 80k moves from the accommodation position to the extraction position is longer than the moving distance L2 of each of the other trays 80y to 80c when the tray moves from the accommodation position to the extraction position.

Thus, in the present exemplary embodiment, when the toner cartridges 70y to 70k are moved from the attachment positions to the retraction positions, a value obtained by dividing the speed of the rack portion 83k by the speed of the driving rack 15 is more than a value obtained by dividing the speed of each of the rack portions 83y to 83c by the speed of the driving rack 15.

For example, as illustrated in FIG. 10, the pinion gear 94y is stepped gears, and the pitch circle radius of a short-diameter gear 942 meshing with the rack portion 83y is shorter than the pitch circle radius of a long-diameter gear 941 meshing with the driving rack 15. The pinion gears 94m and 94c are also similar stepped gears. On the other hand, in the pinion gear 94k, a portion meshing with the driving rack 15 and a portion meshing with the rack portion 83k have the corresponding pitch circle radius. In this case, it is possible to make the pitch circle radius of the pinion gear 94k substantially the same as the pitch circle radius of the long-diameter gear 941 of each of the pinion gears 94y to 94c. According to this configuration, even in a case where the moving distance of the driving rack 15 is the same, it is possible to make the moving distance of the rack portion 83k longer than the moving distances of the other rack portions 83y to 83c. That is, it is possible to make the moving distance L1 of the tray 80k for black when the tray 80k moves from the accommodation position to the extraction position longer than the moving distance L2 of each of the other trays 80y to 80c when the tray moves from the accommodation position to the extraction position.

The pinion gears 94y to 94c are stepped gears, whereby even in a configuration in which the pinion gears 94y to 94k receive a driving force from the same driving rack 15, it is possible to make the moving distance L1 of the tray 80k longer than the moving distance L2 of each of the other trays 80y to 80c.

Instead of (or in combination with) the configuration in which the pinion gears 94y to 94c are stepped gears, the pinion gear 94k may be stepped gear. In this case, a portion of the pinion gear 94k meshing with the driving rack 15 may be a short-diameter gear, and a portion of the pinion gear 94k meshing with the rack portion 83k may be a long-diameter gear having a pitch circle radius longer than that of the short-diameter gear. Stepped gears are an example of a speed reduction mechanism, and may be replaced with a known speed reduction mechanism for making the moving amount of a member on the output side (the tray 80 side) less than the moving amount of a member on the input side (the driving source side).

The moving amount of the driving rack 15 when the toner cartridge 70k is moved from the attachment position to the retraction position may be longer than the moving amount of the driving rack 15 when each of the toner cartridges 70y to 70c is moved from the attachment position to the retraction position.

With the short distance by which the toner cartridge 70 moves from the attachment position to the retraction position, it is possible to make the movement time of the toner cartridge 70 short. Thus, it is possible to shorten the time in which the user waits for the toner cartridge 70 to move. As described above, with the configuration in which the moving amount of the driving rack 15 relative to the toner cartridge 70k is longer than the moving amount of the driving rack 15 relative to each of the toner cartridges 70y to 70c, it is possible to shorten the time in which the user waits for each of the toner cartridges 70y to 70c to move.

Based on the above configurations, it is possible to make the moving distance L1 longer than the moving distance L2. It is also possible to use these configurations in combination.

### (Variations)

Although the configuration has been described in which a driving target portion includes the pinion gear 94 that meshes with both the driving rack 15 and the rack portion 83, the driving target portion may include a gear that meshes with the driving rack 15 and a gear that meshes with the rack portion 83.

The configuration of the movement device 85 that moves the tray 80 is not limited to a so-called rack-and-pinion configuration. For example, a member equivalent to the pinion gear 94 may be replaced with a roller that rotates by receiving drive from the motor M2, and the tray 80 may be moved by the friction between the roller and the tray 80.

In a case where the roller that rotates by receiving drive from the motor M2 is used, the roller and the toner cartridge 70 may abut each other. In this case, the toner cartridges 70y to 70k may be directly attachable to and detachable from the rotary main body 90 not through the trays 80y to 80k, respectively. In this case, the movement device 85 is composed of the roller. Further, in this case, the rotary assembly 90A includes the rotary main body 90 and the toner cartridges 70y to 70k.

<Prevention of Backflow of Toner from Development Unit to Toner Cartridge>

There is a case where the reception opening (development opening) 53b is in a position above the discharge opening 71b according to the rotation of the rotary assembly 90A. For example, in the state in which the toner cartridge 70 is attached to the rotary main body 90, and when the rotary main body 90 is in the replacement posture (an attachment/detachment posture), the reception opening 53b is in the position above the discharge opening 71b. It is desirable that in a case where the reception opening 53b is in the position above the discharge opening 71b, the backflow of toner from the development unit 50 to the toner cartridge 70 be prevented.

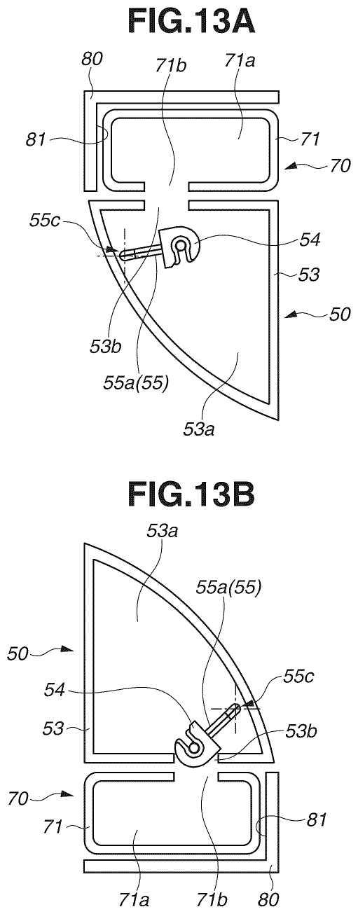

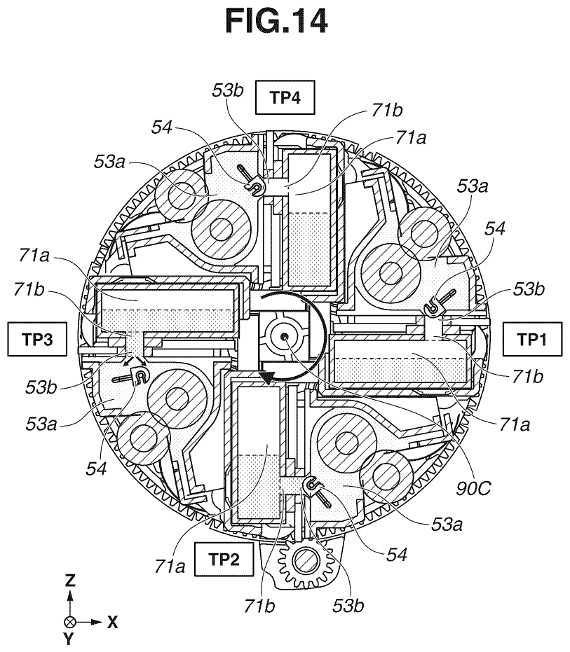

With reference to FIGS. 13A, 13B, and 14, a description is given below of a configuration for preventing the backflow of toner from the development unit 50 to the toner cartridge 70. In the following description, the toner cartridge 70 is attached to the rotary main body 90.

FIGS. 13A and 13B are cross-sectional views of the toner cartridge 70 and the development unit 50 according to the present exemplary embodiment. FIGS. 13A and 13B are cross-sectional views of cross sections in a direction perpendicular to the Y-direction, when viewed in the Y-direction.

As illustrated in FIGS. 13A and 13B, the development unit 50 includes a cover (restriction portion or toner regulating portion) 54. The cover 54 is accommodated in the development side storage portion (reception side storage chamber or development side storage chamber) 53a. The cover 54 is movable relative to the reception opening 53b and is movable to a cover position where the cover 54 covers the reception opening 53b and a retraction position (a cover retraction position) where the cover 54 is retracted from the cover position.

In the present exemplary embodiment, the development unit 50 includes a linked portion 55 that supports the cover 54.

The linked portion 55 is linked to the cover 54 and is movable relative to the reception opening 53b. The linked portion 55 and the cover 54 are configured to move integrally. The linked portion 55 is moved, whereby the cover 54 is moved between the cover position and the cover retraction position. The linked portion 55 includes a shaft (transmission portion) 55a, and the cover 54 is attached to the shaft 55a.

The shaft 55a is swingable about a cover swing axis 55c. The shaft 55a swings, whereby the cover 54 also swings about the cover swing axis 55c and moves between the cover position and the cover retraction position. The details of a configuration for moving the cover 54 will be described below.

As illustrated in FIG. 13B, in the state in which the reception opening 53b is in the position above the discharge opening (discharge port) 71b, the cover 54 is in the cover position. At this time, the cover 54 covers the reception opening 53b, and toner stored in the development side storage portion 53a is restricted from being discharged to outside the development unit 50 through the reception opening 53b. The posture of the rotary main body 90 in which the reception opening 53b is in the position above the discharge opening 71b and the cover 54 is in the cover position is also referred to as a “cover posture (first posture)”.

FIG. 13B is also a diagram illustrating the state in which the rotary main body 90 is in the first posture in the state in which the toner cartridge 70 is attached to the rotary main body 90. In other words, FIG. 13B is also a diagram illustrating the state in which the rotary assembly 90A is in the first posture.

As illustrated in FIG. 13A, in the state in which the reception opening 53b is in the position below the discharge opening 71b, the cover 54 is in the cover retraction position where the cover 54 is retracted from the cover position. In this state, a gap through which toner passes is formed between the cover 54 and the reception opening 53b. When the cover 54 is in the cover retraction position, toner discharged from the discharge opening 71b is allowed to pass between the cover 54 and the reception opening 53b and enter the development side storage portion 53a. The posture of the rotary main body 90 in which the reception opening 53b is in the position below the discharge opening 71b and the cover 54 is in the cover retraction position is also referred to as a “cover retraction posture (second posture)”.

FIG. 13A is also a diagram illustrating the state in which the rotary main body 90 is in the second posture in the state in which the toner cartridge 70 is attached to the rotary main body 90. In other words, FIG. 13A is also a diagram illustrating the state in which the rotary assembly 90A is in the second posture.

In the present exemplary embodiment, when the rotary main body 90 is in the cover retraction posture, the weight of the cover 54 itself acts from the cover position toward the cover retraction position. Further, when the rotary main body 90 is in the cover posture, the weight of the cover 54 itself acts from the cover retraction position toward the cover position.

In the state in which the cover 54 is in the cover position, the reception opening 53b does not need to be completely closed by the cover 54. That is, the discharge of toner from the reception opening 53b does not need to be completely restricted by the cover 54. For example, in the state in which the cover 54 is in the cover position, a gap may be formed between the cover 54 and the reception opening 53b. In this case, the size of the gap formed between the cover 54 and the reception opening 53b when the cover 54 is in the cover position is smaller than the size in the state in which the cover 54 is in the cover retraction position.

In the state in which the cover 54 is in the cover position, the cover 54 may block the reception opening 53b so that a gap does not occur between the cover 54 and the reception opening 53b. That is, the discharge of toner from the reception opening 53b may be completely restricted.

FIG. 14 is a cross-sectional view of the rotary assembly 90A according to the present exemplary embodiment. FIG. 14 is a cross-sectional view of a cross section in a direction perpendicular to the Y-direction, when viewed in the Y-direction. FIG. 14 illustrates the state in which the development unit 50 and the toner cartridge 70 corresponding to the development unit 50 are in each of positions TP1, TP2, TP3, and TP4.

When the rotary main body 90 to which the toner cartridge 70 is attached is in the replacement posture, the development unit 50 and the toner cartridge 70 are in the position TP1. At this time, the reception opening 53b is in the position above the discharge opening 71b, and the cover 54 is in the cover position. In this state, the backflow of toner from the development unit 50 to the toner cartridge 70 is prevented. Thus, the leakage of toner is prevented in replacement of the toner cartridge 70.

The cover 54 prevents toner discharged once from the toner cartridge 70 from returning to the toner cartridge 70. Thus, it is possible to decrease the amount of toner remaining inside the toner cartridge 70 after the toner cartridge 70 is used. In other words, more toner stored in the toner cartridge 70 is used up.

In the present exemplary embodiment, the rotary main body 90 to which the toner cartridge 70 is attached rotates clockwise when viewed in the Y-direction, rotates from the position TP1 to the positions TP2, TP3, and TP4 in this order, and returns to the position TP1 again. When the development unit 50 and the toner cartridge 70 are in the position TP2, the reception opening 53b and the discharge opening 71b are in positions below the rotational axis 90C, and the reception opening 53b is arranged next to the discharge opening 71b in the horizontal direction. When the development unit 50 and the toner cartridge 70 are in the position TP3, the reception opening 53b is in a position below the discharge opening 71b. When the development unit 50 and the toner cartridge 70 are in the position TP4, the reception opening 53b and the discharge opening 71b are in positions above the rotational axis 90C, and the reception opening 53b is arranged next to the discharge opening 71b in the horizontal direction.

In the present exemplary embodiment, when the development unit 50 and the toner cartridge 70 are in the position TP4, and when the development unit 50 and the toner cartridge 70 are in the position TP2, the cover 54 is in the cover position. When the development unit 50 and the toner cartridge 70 move from the position TP4 through the position TP1 to the position TP2, at least a part of the reception opening 53b is in the position above the discharge opening 71b. In the present exemplary embodiment, while the development unit 50 and the toner cartridge 70 move from the position TP4 through the position TP1 to the position TP2 by the rotation of the rotary assembly 90A, the cover 54 is in the cover position.

On the other hand, when the development unit 50 and the toner cartridge 70 are in the position TP3, the cover 54 is in the cover retraction position. In the present exemplary embodiment, the position where the development roller 51 of the development unit 50 is opposed to the photosensitive drum 2 is downstream of the position TP3 and upstream of the position TP4. In other words, while the posture of the rotary main body 90 changes from the replacement posture to the development posture, the rotary main body 90 is in the cover retraction posture, and the cover 54 is in the cover retraction position. In the present exemplary embodiment, when the development unit 50 is in the development position, the reception opening 53b is in the position below the discharge opening 71b, and the cover 54 is in the cover retraction position.

When the rotary main body 90 rotates, and after the development unit 50 and the toner cartridge 70 pass through the position TP2, the cover 54 moves to the cover retraction position. Before the development unit 50 and the toner cartridge 70 reach the position TP4, the cover 54 moves to the cover position. As a result, in the state in which at least a part of the reception opening 53b is in the position above the discharge opening 71b, the cover 54 is in the cover position, and the backflow of toner from the development unit 50 to the toner cartridge 70 is prevented more securely.

### <Movement of Cover>

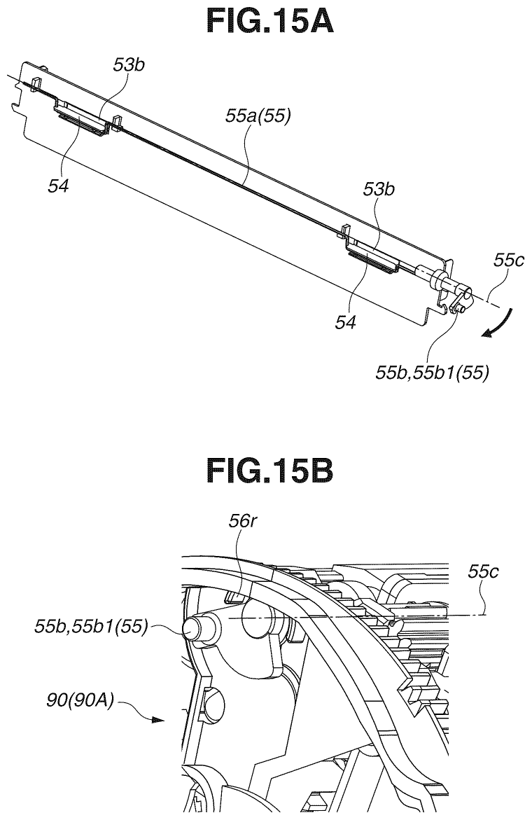

With reference to FIGS. 15A, 15B, 16A, 16B, 17A, 17B, 18A, 18B, 18C, 19A, 19B, and 19C, the configuration of the cover 54 and the configuration for moving the cover 54 are described.

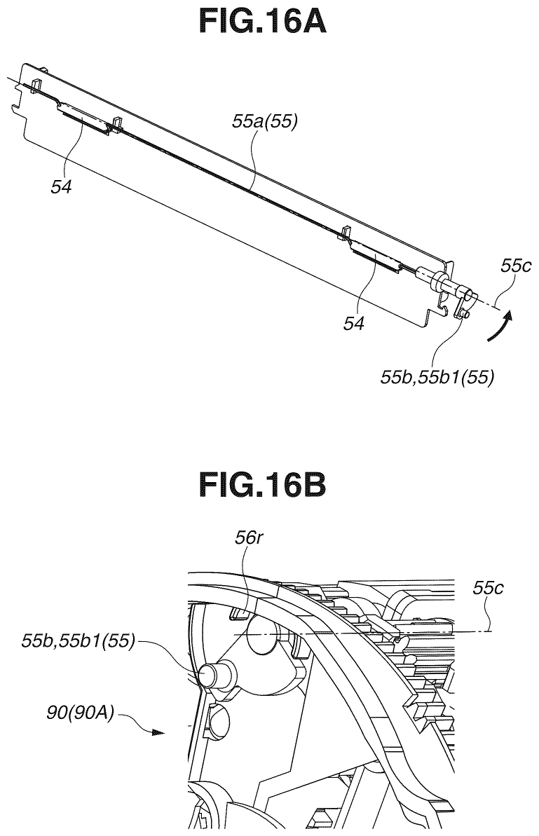

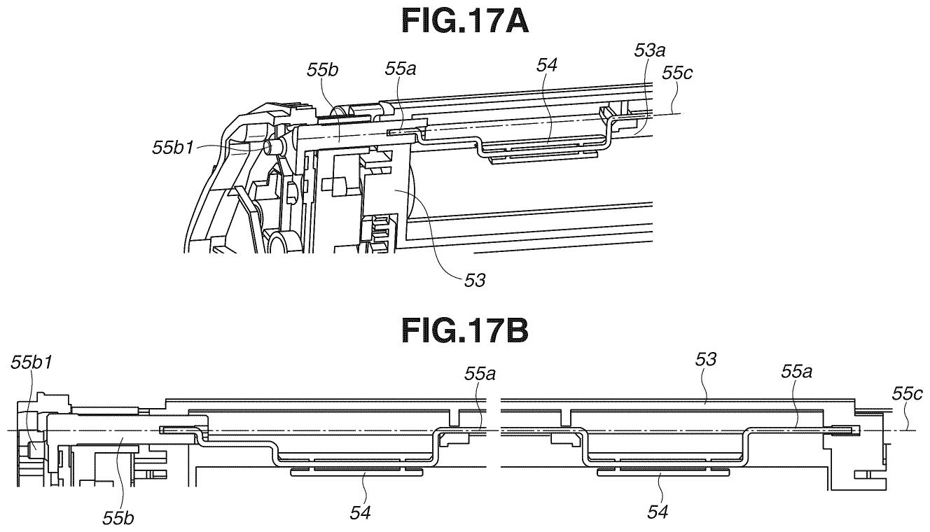

FIGS. 15A, 15B, 16A, and 16B are diagrams illustrating the configurations of the cover 54 and the linked portion 55 according to the present exemplary embodiment. In FIGS. 15A and 15B, the cover 54 is in the cover retraction position. In FIGS. 16A and 16B, the cover 54 is in the cover position. FIGS. 15A and 16A are diagrams illustrating the inside of the development unit 50. FIGS. 15B and 16B are perspective views of the rotary main body 90 viewed from outside the development unit 50. FIGS. 17A and 17B are cross-sectional views of the development unit 50.

As illustrated in FIGS. 15A and 16A, in the present exemplary embodiment, a plurality of reception openings 53b is included in the development frame 53. Further, the development unit 50 includes a plurality of covers 54. In other words, the development opening includes a plurality of reception openings 53b, and the restriction portion (the toner regulating portion) includes a plurality of covers 54. When the plurality of covers 54 is in the cover position, the plurality of covers 54 covers the plurality of reception openings 53b. When the plurality of covers 54 is in the cover retraction position, toner discharged from the toner cartridge 70 is allowed to pass between the plurality of covers 54 and the plurality of reception openings 53b and enter the development side storage portion 53a.

Although the number of reception openings 53b is two in the present exemplary embodiment, the number of reception openings 53b may be one, or may be more than two. The cover 54 is placed corresponding to each reception opening 53b. Thus, the number of covers 54 may be one, or may be more than two.

As described above, the development unit 50 includes the linked portion 55. The linked portion 55 includes the shaft 55a swingable about the cover swing axis 55c, and the cover 54 is attached to the shaft 55a. Hereinafter, the direction in which the cover swing axis 55c extends will be referred to as a “swing axis direction”. In the present exemplary embodiment, the swing axis direction is parallel to the direction of the rotational axis 90C.

With respect to a direction orthogonal to the swing axis direction, the cover 54 is placed at a position away from the cover swing axis 55c. More specifically, the shaft 55a is curved, and a portion overlapping the cover swing axis 55c and a portion away from the cover swing axis 55c are formed in the shaft 55a. The cover 54 is attached to the portion away from the cover swing axis 55c.

The linked portion 55 includes a reception portion (holding target portion) 55b attached to the shaft 55a. The reception portion 55b is moved, whereby the cover 54 moves to the cover position and the cover retraction position through the shaft 55a. As illustrated in FIGS. 17A and 17B, the reception portion 55b is attached to one end of the shaft 55a, and the other end of the shaft 55a is supported by the development frame 53.

The reception portion 55b is rotatably supported by a development frame 53c and includes a projection portion (abutment portion or restriction target portion) 55b1. The cover 54 is accommodated in the development side storage portion 53a, whereas the projection portion 55b1 is set outside the development side storage portion 53a. With respect to the direction orthogonal to the swing axis direction, the projection portion 55b1 is placed at a position away from the cover swing axis 55c. The projection portion 55b1 is moved, whereby the cover 54 moves to the cover position and the cover retraction position. In other words, the projection portion 55b1 is linked to the cover 54 so that the cover 54 moves in conjunction with the projection portion 55b1. In the present exemplary embodiment, the rotary main body 90 includes a movement restriction portion 56r opposed to the reception portion 55b.

As is understood from FIGS. 15B and 16B, the position of the projection portion 55b1 when the cover 54 is in the cover retraction position is further away from the rotational axis 90C of the rotary main body 90 than the position of the projection portion 55b1 when the cover 54 is in the cover position is. That is, with respect to a direction orthogonal to the rotational axis 90C, in response to the projection portion 55b1 moving in a direction away from the rotational axis 90C, the cover 54 moves from the cover position toward the cover retraction position. With reference to the direction orthogonal to the rotational axis 90C, in response to the projection portion 55b1 moving in a direction toward the rotational axis 90C, the cover 54 moves from the cover retraction position toward the cover position. In other words, the projection portion 55b1 when the cover 54 is in the cover position (see FIG. 16B) is moved in the direction away from the rotational axis 90C, whereby the cover 54 moves to the cover retraction position. The projection portion 55b1 when the cover 54 is in the cover retraction position (see FIG. 15B) is moved in the direction toward the rotational axis 90C, whereby the cover 54 moves to the cover position.

The projection portion 55b1 is moved according to the rotation of the rotary main body 90. The rotation of the rotary main body 90 and the movement of the projection portion 55b1 are described below.

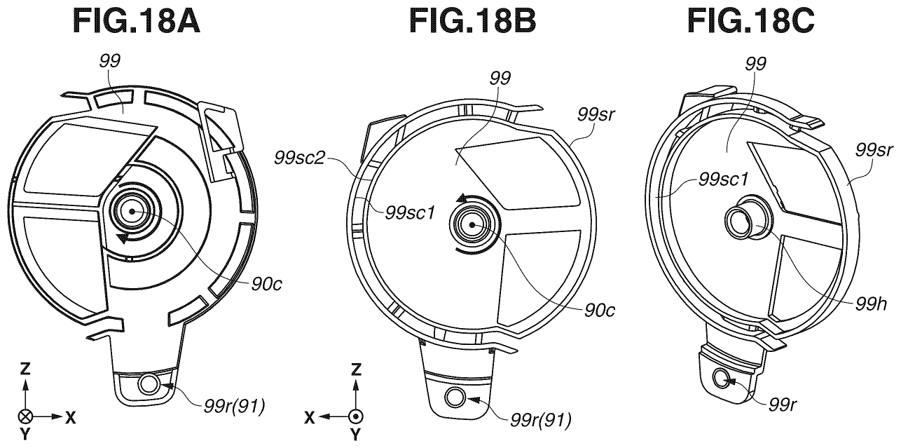

FIGS. 18A, 18B, and 18C are diagrams illustrating a rotary holder 99 that supports the rotary main body 90. FIG. 18A is a view of the rotary holder 99 in the Y-direction. FIG. 18B is a view of the rotary holder 99 in a direction opposite to the Y-direction. FIG. 18C is a perspective view of the rotary holder 99.

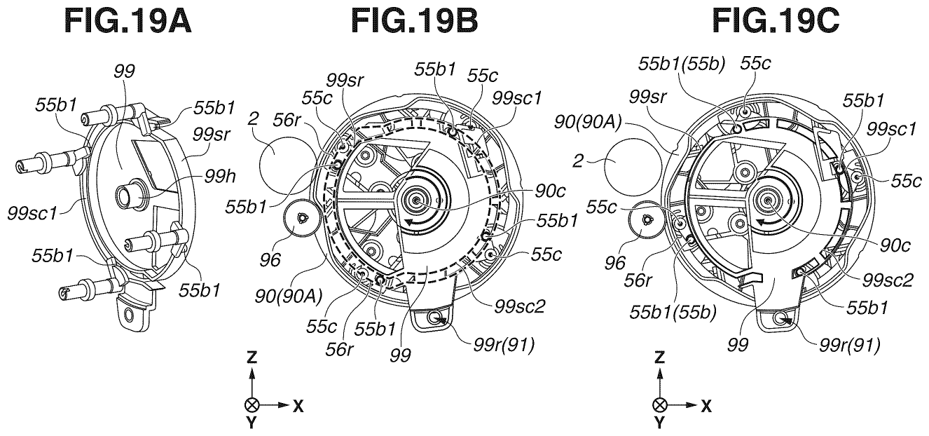

FIGS. 19A, 19B, and 19C are diagrams illustrating the relationship between the rotation of the rotary main body 90 and the movement of the projection portion 55b1 relative to the rotary holder 99. FIG. 19A is a perspective view illustrating the rotary holder 99 and the projection portion 55b1. FIGS. 19B and 19C are side views of the rotary holder 99 and the rotary main body 90. FIGS. 19B and 19C are views of the rotary holder 99 and the rotary main body 90 in the Y-direction.

The apparatus main body 1A includes a rotary holder (rotary joining member or rotary supporting member) 99. The rotary holder 99 includes a rotary linked portion (rotary supporting portion) 99h. The rotary main body 90 (the rotary assembly 90A) is supported rotatably about the rotational axis 90C by the rotary linked portion 99h. A joining hole 99r is included in the rotary holder 99.

The rotary holder 99 is swingable so that the rotational axis 90C of the rotary main body 90 is displaced. More specifically, the swing shaft 91 (FIG. 5) is inserted into the joining hole 99r. Consequently, the rotary holder 99 is supported swingably about the swing shaft 91. When the rotary cams 90eL and 90eR (FIG. 5) abut the roller 96, the rotary holder 99 swings about the swing shaft 91. As a result, the rotary main body 90 swings about the swing shaft 91. In FIG. 19B, the rotary main body 90 is in the development posture, and the rotational axis 90C of the rotary main body 90 is in a position close to the photosensitive drum 2. In FIG. 19C, the rotary main body 90 is in the replacement posture, and the rotational axis 90C of the rotary main body 90 is in a position away from the photosensitive drum 2.

The rotary holder 99 includes a surface 99sr, a surface 99sc1, and a surface 99sc2. In the present exemplary embodiment, the surfaces 99sr, 99sc1, and 99sc2 have arc shapes centered at the rotational axis 90C. The length of the arc shape of the surface 99sc1 is longer than half the circumference of a circle having substantially the same radius as the radius of the arc shape of the surface 99sc1. The length of the arc shape of the surface 99sc2 is longer than half the circumference of a circle having substantially the same radius as the radius of the arc shape of the surface 99sc2.

The rotary main body 90 rotates relative to the rotary holder 99, whereby the projection portion 55b1 is displaced relative to the surfaces 99sr, 99sc1, and 99sc2. Specifically, the projection portion 55b1 rotates about each of the center of the arc shape of the surface 99sr, the center of the arc shape of the surface 99s1, and the center of the arc shape of the surface 99s2. The surfaces 99sr, 99sc1, and 99sc2 form a guide portion that guides the linked portion 55. In other words, the guide portion that guides the linked portion 55 includes the surfaces 99sr, 99sc1, and 99sc2. The projection portion 55b1 as a part of the linked portion 55 is engaged with the guide portion.

The rotary main body 90 rotates relative to the rotary holder 99, whereby the projection portion 55b1 passes through a portion indicated by dotted lines in FIG. 19B. The position where the projection portion 55b1 abuts the surface 99sr is further away from the rotational axis 90C than the position where the projection portion 55b1 abuts the surface 99sc1 is. The position where the projection portion 55b1 abuts the surface 99sr is further away from the rotational axis 90C than the position where the projection portion 55b1 abuts the surface 99sc2 is.

Each of the surfaces 99sr, 99sc1, and 99sc2 has a function as a holding portion that holds the cover 54 at the cover position or the cover retraction position. When the rotary main body 90 rotates about the rotational axis 90C, the projection portion 55b1 is displaced relative to the holding portions (the surface 99sr, 99sc1, and 99sc2). When the rotary main body 90 (the rotary assembly 90A) rotates relative to the rotary holder 99, the linked portion 55 abuts each of the surfaces 99sr, 99sc1, and 99sc2, whereby the cover 54 is in the cover position or the cover retraction position.

In the state in which the projection portion 55b1 as a part of the linked portion 55 abuts the surface 99sr, the cover 54 is in the cover retraction position. The surface 99sr restricts the cover 54 from moving from the cover retraction position toward the cover position. More specifically, when the projection portion 55b1 abuts the surface 99sr and the cover 54 is in the cover retraction position, the surface 99sr is closer to the rotational axis 90C than the projection portion 55b1. That is, with respect to the moving direction of the projection portion 55b1 when the cover 54 moves from the cover retraction position toward the cover position, the surface 99sr is in the position downstream of the projection portion 55b1. Thus, the movement of the projection portion 55b1 is restricted, and the cover 54 is restricted from moving from the cover retraction position toward the cover position.

In the state in which the projection portion 55b1 of the linked portion 55 abuts the surface 99sr, and in a case where the linked portion 55 moves in the direction in which the projection portion 55b1 goes away from the rotational axis 90C, the reception portion 55b abuts the movement restriction portion 56r. Thus, the moving distance of the cover 54 in a direction away from the reception opening 53b is limited within a predetermined range.

In the state in which the projection portion 55b1 abuts the surface 99sc1, the cover 54 is in the cover position. The surface 99sc1 restricts the cover 54 from moving from the cover position toward the cover retraction position. More specifically, when the projection portion 55b1 abuts the surface 99sc1 and the cover 54 is in the cover position, the surface 99sc1 is further away from the rotational axis 90C than the projection portion 55b1. That is, with respect to the moving direction of the projection portion 55b1 when the cover 54 moves from the cover position toward the cover retraction position, the surface 99sc1 is in the position downstream of the projection portion 55b1. Thus, the movement of the projection portion 55b1 is restricted, and the cover 54 is restricted from moving from the cover position toward the cover retraction position.

As described above, when the cover 54 is in the cover position, toner may be completely restricted from passing between the cover 54 and the reception opening 53b. In this case, for example, the cover 54 may have elasticity, and the cover 54 may be deformed by abutting the periphery of the reception opening 53b in the state in which the cover 54 is in the cover position.

In the state in which the projection portion 55b1 abuts the surface 99sc2, the cover 54 is in the cover position. In the state in which the projection portion 55b1 of the linked portion 55 abuts the surface 99sc2, the movement of the linked portion 55 is restricted in the direction in which the projection portion 55b1 comes close to the rotational axis 90C.

In a case where the size of the projection portion 55b1 is shorter than the distance between the surfaces 99sc1 and 99sc2, the position of the cover 54 in the case where the projection portion 55b1 abuts the surface 99sc1 and the position of the cover 54 in the case where the projection portion 55b1 abuts the surface 99sc2 are not completely the same as each other. However, both in the case where the projection portion 55b1 abuts the surface 99sc1 and the case where the projection portion 55b1 abuts the surface 99sc2, the cover 54 prevents the discharge of toner from the reception opening 53b. Thus, both the position of the cover 54 in the case where the projection portion 55b1 abuts the surface 99sc1 and the position of the cover 54 in the case where the projection portion 55b1 abuts the surface 99sc2 is also referred to as the “cover position”.

As described above, the surface (first restriction portion) 99sc1 is configured to restrict the cover 54 from moving from the cover position toward the cover retraction position when the rotary main body 90 (the rotary assembly 90A) is in the cover posture. The surface (second restriction portion) 99sr is configured to restrict the cover 54 from moving from the cover retraction position toward the cover position when the rotary main body 90 (the rotary assembly 90A) is in the cover retraction posture.

When the rotary main body 90 (the rotary assembly 90A) rotates relative to the rotary holder 99, the projection portion 55b1 is a position upstream of the cover swing axis 55c. Consequently, the projection portion 55b1 smoothly moves while sliding in contact with the surfaces 99sr, 99sc1, and 99sc2.

After the rotary main body 90 (the rotary assembly 90A) rotates relative to the rotary holder 99 and the development unit 50 and the toner cartridge 70 pass through the position TP2 (see FIG. 14), the projection portion 55b1 abuts the surface 99sr. As a result, the cover 54 is in the cover retraction position. The surface 99sr is also referred to as a “holding surface (second holding surface)” that abuts the projection portion 55b1 and holds the cover 54 at the cover retraction position. The projection portion 55b1 abuts the surface 99sr, whereby the cover 54 is restricted from being retracted from the cover retraction position. In the present exemplary embodiment, when the development unit 50 is in the development position, the projection portion 55b1 abuts the surface 99sr. In the state in which the cover 54 is in the cover retraction position, toner discharged from the discharge opening 71b of the toner cartridge 70 is allowed to be supplied to the development unit 50.

In response to the rotary main body 90 (the rotary assembly 90A) further rotating relative to the rotary holder 99 from the state in which the development unit 50 is in the development position, before the development unit 50 and the toner cartridge 70 reach the position TP4 (see FIG. 14), the projection portion 55b1 goes away from the surface 99sr.

After the projection portion 55b1 goes away from the surface 99sr, and before the development unit 50 and the toner cartridge 70 reach the position TP4, the projection portion 55b1 enters a guide groove formed by the surfaces 99sc1 and 99sc2. In the present exemplary embodiment, the width of the guide groove is longer than that of the projection portion 55b1. The projection portion 55b1 in the guide groove abuts at least one of the surfaces 99sc1 and 99sc2. In the state in which the projection portion 55b1 is in the guide groove, the cover 54 is in the cover position.

In the present exemplary embodiment, when the rotary main body 90 (the rotary assembly 90A) is in the replacement posture, the projection portion 55b1 is in the state of being in the guide groove and abuts at least one of the surfaces 99sc1 and 99sc2. At least one of the surfaces 99sc1 and 99sc2 is also referred to as a “holding surface (first holding surface)” that abuts the projection portion 55b1 and holds the cover 54 at the cover position. The projection portion 55b1 abuts at least one of the surfaces 99sc1 and 99sc2, whereby the cover 54 is restricted from being retracted from the cover position. Thus, when the rotary main body 90 (the rotary assembly 90A) is in the replacement posture, the cover 54 is in the cover position. Further, when the rotary main body 90 (the rotary assembly 90A) is in the replacement posture, the cover 54 is restricted from moving to the cover retraction position. As a result, when the rotary main body 90 (the rotary assembly 90A) is in the replacement posture, the cover 54 prevents the backflow of toner from the development unit 50 to the toner cartridge 70.

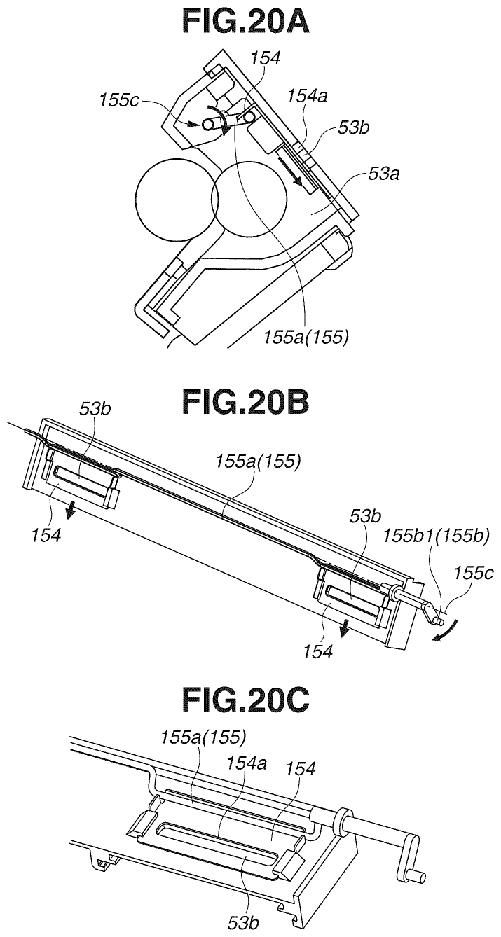

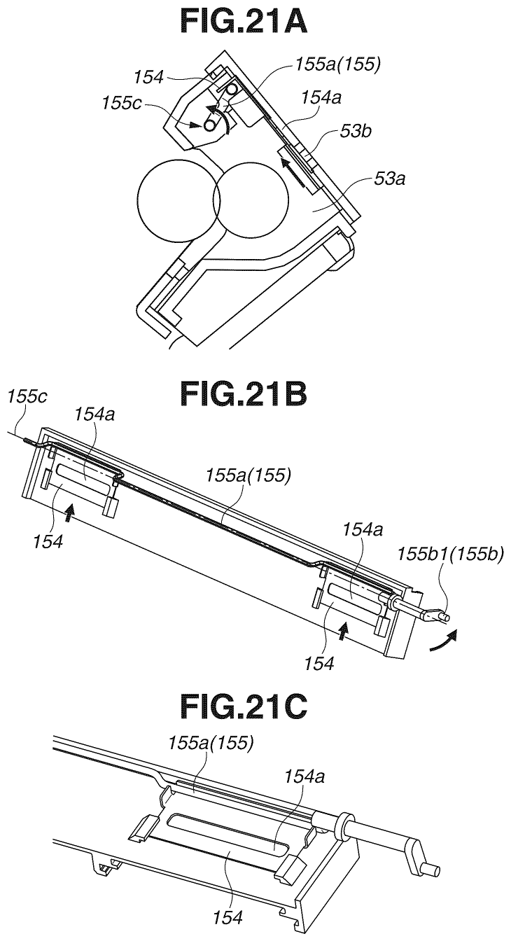

With reference to FIGS. 20A, 20B, 20C, 21A, 21B, and 21C, a description is given of a configuration for preventing the backflow of toner from the development unit 50 to the toner cartridge 70 according to a second exemplary embodiment. In the second exemplary embodiment, components similar to the components described in the first exemplary embodiment are designated by the same signs, and are not described in detail as a rule.

FIGS. 20A, 20B, 20C, 21A, 21B, and 21C are diagrams illustrating the configurations of a cover 154 as a restriction portion and a linked portion 155 linked to the cover 154 according to the second exemplary embodiment. In FIGS. 21A, 21B, and 21C, the cover 154 is in a cover position, and the cover 154 covers the reception opening 53b. In FIGS. 20A, 20B, and 20C, the cover 154 is in a cover retraction position where the cover 154 is retracted from the cover position.

The development unit 50 includes a cover 154 as a restriction portion (a toner regulating portion). The cover 154 is accommodated in the development side storage portion 53a. The cover 154 is movable relative to the reception opening 53b and is movable to a cover position where the cover 154 covers the reception opening 53b and a cover retraction position where the cover 154 is retracted from the cover position.

In the present exemplary embodiment, the development unit 50 includes a linked portion 155 that supports the cover 154. The linked portion 155 is linked to the cover 154 and is movable relative to the reception opening 53b. The linked portion 155 and the cover 154 are configured to move integrally. The linked portion 155 is moved, whereby the cover 154 is moved between the cover position and the cover retraction position. The linked portion 155 includes a shaft (transmission portion) 155a, and the cover 154 is attached to the shaft 155a. The shaft 155a is swingable about a cover swing axis 155c. The shaft 155a swings, whereby the cover 154 linearly moves and moves between the cover position and the cover retraction position.

The cover 154 includes a hole 154a. When the cover 154 is in the cover position, the hole 154a does not overlap the reception opening 53b. When the cover 154 is in the cover retraction position, the hole 154a overlaps the reception opening 53b, and toner discharged from the toner cartridge 70 enters the reception side storage portion 53a through the reception opening 53b and the hole 154a.

In the state in which the cover 154 is in the cover position, the reception opening 53b does not need to be completely closed by the cover 154. That is, the discharge of toner from the reception opening 53b does not need to be completely restricted by the cover 154. In the state in which the cover 154 is in the cover position, the cover 154 may block the reception opening 53b so that a gap does not occur between the cover 154 and the reception opening 53b. That is, the discharge of toner from the reception opening 53b may be completely restricted.

In the present exemplary embodiment, a plurality of reception openings 53b is included in the development frame 53. Further, the development unit 50 includes a plurality of covers 154. In other words, the development opening includes a plurality of reception openings 53b, and the restriction portion (the toner regulating portion) includes a plurality of covers 154. When the plurality of covers 154 is in the cover position, the plurality of covers 154 covers the plurality of reception openings 53b. When the plurality of covers 154 is in the cover retraction position, toner discharged from the toner cartridge 70 is allowed to pass through the hole 154a of each of the plurality of covers 154 and the plurality of reception openings 53b and enter the development side storage portion 53a.

Although the number of reception openings 53b is two in the present exemplary embodiment, the number of reception openings 53b may be one, or may be more than two. The cover 154 is placed corresponding to each reception opening 53b. Thus, the number of covers 154 may be one, or may be more than two.

As described above, the development unit 50 includes the linked portion 155. The linked portion 155 includes the shaft 155a swingable about the cover swing axis 155c, and the cover 154 is attached to the shaft 155a. Hereinafter, the direction in which the cover swing axis 155c extends will be referred to as a “swing axis direction”. In the present exemplary embodiment, the swing axis direction is parallel to the direction of the rotational axis 90C.

With respect to a direction orthogonal to the swing axis direction, the cover 154 is placed at a position away from the cover swing axis 155c. More specifically, the shaft 155a is curved, and a portion overlapping the cover swing axis 155c and a portion away from the cover swing axis 155c are formed in the shaft 155a. The cover 154 is attached to the portion away from the cover swing axis 155c.

The linked portion 155 includes a reception portion (holding target portion) 155b attached to the shaft 155a. The reception portion 155b is moved, whereby the cover 154 moves to the cover position and the cover retraction position through the shaft 155a. The reception portion 155b is attached to one end of the shaft 155a, and the other end of the shaft 155a is supported by the development frame 53.

The reception portion 155b is rotatably supported by the development frame 53c and includes a projection portion (abutment portion or restriction target portion) 155b1. The cover 154 is accommodated in the development side storage portion 53a, whereas the projection portion 155b1 is set outside the development side storage portion 53a. With respect to the direction orthogonal to the swing axis direction, the projection portion 155b1 is placed at a position away from the cover swing axis 155c. The projection portion 155b1 is moved, whereby the cover 154 moves to the cover position and the cover retraction position. In other words, the projection portion 155b1 is linked to the cover 154 so that the cover 154 moves in conjunction with the projection portion 155b1.

Also in the present exemplary embodiment, similarly to the first exemplary embodiment, the projection portion 155b1 abuts holding portions of the rotary holder 99, whereby the cover 154 is moved to the cover position and the cover retraction position. That is, also in the present exemplary embodiment, the rotary holder 99 includes portions equivalent to the surfaces 99sr, 99sc1, and 99sc2 according to the first exemplary embodiment. The shapes and the placement of these portions are appropriately changeable so that the timings when the cover 154 moves to the cover position and the cover retraction position are similar to those in the first exemplary embodiment.

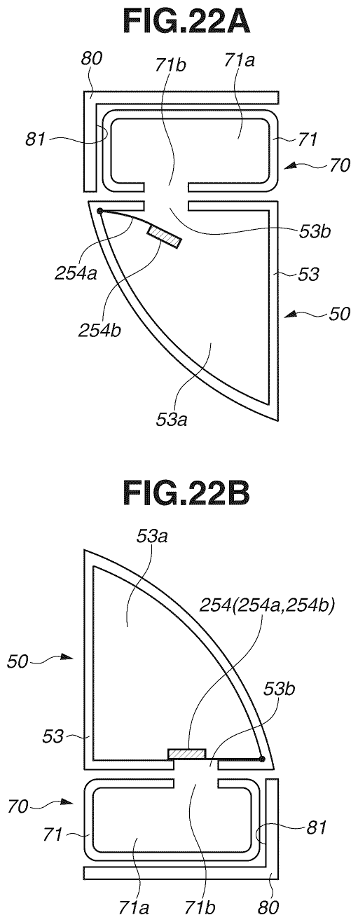

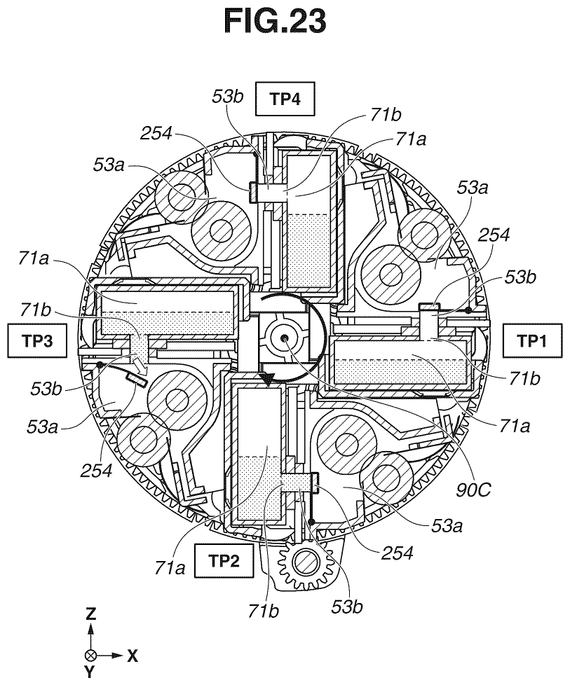

With reference to FIGS. 22A, 22B, and 23, a description is given of a configuration for preventing the backflow of toner from the development unit 50 to the toner cartridge 70 according to a third exemplary embodiment. In the third exemplary embodiment, components similar to the components described in the first exemplary embodiment are designated by the same signs, and are not described in detail as a rule.

FIGS. 22A and 22B are cross-sectional views of the toner cartridge 70 and the development unit 50 according to the present exemplary embodiment. FIGS. 22A and 22B are cross-sectional views of cross sections in a direction perpendicular to the Y-direction, when viewed in the Y-direction.

As illustrated in FIGS. 22A and 22B, the development unit 50 includes a cover 254 as a restriction portion (a toner regulating portion). The cover 254 is accommodated in the development side storage portion (reception side storage chamber or development side storage chamber) 53a. The cover 254 is movable to a cover position where the cover 254 covers the reception opening 53b as a development opening and a cover retraction position where the cover 254 is retracted from the cover position. The cover 254 includes a sheet portion (cover main body) 254a and a weight 254b.

The sheet portion 254a of the cover 254 includes one end portion fixed to the development frame 53 and an other end portion opposite to the one end portion. When the cover 254 moves between the cover position and the cover retraction position, the sheet portion 254a of the cover 254 deforms between the one end portion and the other end portion. When viewed in the direction of the rotational axis 90C of the rotary main body 90, the other end portion is closer to the rotational axis 90C than the one end portion is.

As illustrated in FIG. 22B, in the state in which the reception opening 53b is in the position above the discharge opening (discharge port) 71b, the cover 254 is in the cover position. At this time, the cover 254 covers the reception opening 53b, and toner stored in the development side storage portion 53a is restricted from being discharged to outside the development unit 50 through the reception opening 53b. The posture of the rotary main body 90 in which the reception opening 53b is in the position above the discharge opening 71b and the cover 254 is in the cover position is also referred to as a “cover posture (first posture)”.

As illustrated in FIG. 22A, in the state in which the reception opening 53b is in the position below the discharge opening 71b, the cover 254 is in the cover retraction position where the cover 254 is retracted from the cover position. At this time, a gap through which toner discharged from the discharge opening 71b passes is formed between the cover 254 and the reception opening 53b. When the cover 254 is in the cover retraction position, toner is allowed to pass between the cover 254 and the reception opening 53b and enter the development side storage portion 53a. The posture of the rotary main body 90 in which the reception opening 53b is in the position below the discharge opening 71b and the cover 254 is in the cover retraction position is also referred to as a “cover retraction posture (second posture)”.

In the present exemplary embodiment, when the rotary main body 90 is in the cover retraction posture, the weight of the cover 254 itself acts from the cover position toward the cover retraction position. Further, when the rotary main body 90 is in the cover posture, the weight of the cover 254 itself acts from the cover retraction position toward the cover position. The rotary main body 90 rotates, whereby the direction in which the weight of the cover 254 itself acts changes. The direction in which the weight of the cover 254 itself acts changes, whereby the cover 254 according to the present exemplary embodiment is movable to the cover retraction position and the cover position. The cover 254 includes the weight 254b, whereby the weight of the cover 254 itself increases. Thus, the cover 254 is likely to move under the weight of the cover 254 itself. In a case where the weight of the sheet portion 254a itself is sufficiently heavy, the cover 254 does not need to include the weight 254b.

The cover 254 according to the present exemplary embodiment is configured to move between the cover position and the cover retraction position under the weight of the cover 254 itself.

In the present exemplary embodiment, the sheet portion 254a is configured to be elastically deformable. In a natural state of the sheet portion 254a (the state in which the sheet portion 254a is not deformed), the cover 254 is in the cover position. When the cover 254 moves from the cover position to the cover retraction position, the sheet portion 254a is deformed, and therefore, the cover 254 moves under the weight of the cover 254 itself against the restoring force of the sheet portion 254a. When the cover 254 moves from the cover retraction position to the cover position, the deformation of the sheet portion 254a is resolved, and therefore, the cover 254 moves by the restoring force of the sheet portion 254a and under the weight of the cover 254 itself.

When the cover 254 moves from the cover retraction position to the cover position, the cover 254 may move under the weight of the cover 254 itself against the restoring force of the sheet portion 254a. In this case, when the cover 254 moves from the cover position to the cover retraction position, the cover 254 moves by the restoring force of the sheet portion 254a and under the weight of the cover 254 itself.

A cover main body equivalent to the sheet portion 254a may not substantially deform, and may be supported movably relative to the development frame 53. In this case, the cover 254 moves from the cover retraction position to the cover position under the weight of the cover 254 itself and further moves from the cover position to the cover retraction position under the weight of the cover 254 itself.

In the state in which the cover 254 is in the cover position, the reception opening 53b does not need to be completely closed by the cover 254. That is, the discharge of toner from the reception opening 53b does not need to be completely restricted by the cover 254. For example, in the state in which the cover 254 is in the cover position, a gap may be formed between the cover 254 and the reception opening 53b. In this case, the size of the gap formed between the cover 254 and the reception opening 53b when the cover 254 is in the cover position is less than the size in the state in which the cover 254 is in the cover retraction position.

In the state in which the cover 254 is in the cover position, the cover 254 may block the reception opening 53b so that a gap does not occur between the cover 254 and the reception opening 53b. That is, the discharge of toner from the reception opening 53b is completely restricted.

FIG. 23 is a cross-sectional view of the rotary assembly 90A according to the present exemplary embodiment. FIG. 23 is a cross-sectional view of a cross section in a direction perpendicular to the Y-direction, when viewed in the Y-direction. FIG. 23 illustrates the state in which the development unit 50 and the toner cartridge 70 corresponding to the development unit 50 are in each of positions TP1, TP2, TP3, and TP4.

When the rotary main body 90 is in the replacement posture, the development unit 50 and the toner cartridge 70 are in at the position TP1. At this time, the reception opening 53b is in the position above the discharge opening 71b, and the cover 254 is in the cover position. In this state, the backflow of toner from the development unit 50 to the toner cartridge 70 is prevented. Thus, the leakage of toner is prevented in replacement of the toner cartridge 70. Toner discharged once from the toner cartridge 70 is prevented from returning to the toner cartridge 70. Thus, it is possible to decrease the amount of toner remaining inside the toner cartridge 70 after the toner cartridge 70 is used. In other words, more toner stored in the toner cartridge 70 is used up.

In the present exemplary embodiment, the rotary main body 90 rotates clockwise when viewed in the Y-direction, rotates from the position TP1 to the positions TP2, TP3, and TP4 in this order, and returns to the position TP1 again. When the development unit 50 and the toner cartridge 70 are in the position TP2, the reception opening 53b and the discharge opening 71b are in the positions below the rotational axis 90C, and the reception opening 53b is arranged next to the discharge opening 71b in the horizontal direction. When the development unit 50 and the toner cartridge 70 are in the position TP3, the reception opening 53b is in the position below the discharge opening 71b. When the development unit 50 and the toner cartridge 70 are in the position TP4, the reception opening 53b and the discharge opening 71b are in the positions above the rotational axis 90C, and the reception opening 53b is arranged next to the discharge opening 71b in the horizontal direction.

In the present exemplary embodiment, when the development unit 50 and the toner cartridge 70 are in the position TP4, and when the development unit 50 and the toner cartridge 70 are in the position TP2, the cover 254 is in the cover position. When the development unit 50 and the toner cartridge 70 move from the position TP4 through the position TP1 to the position TP2, at least a part of the reception opening 53b is in the position above the discharge opening 71b. In the present exemplary embodiment, while the development unit 50 and the toner cartridge 70 move from the position TP4 through the position TP1 to the position TP2 by the rotation of the rotary assembly 90A, the cover 254 is in the cover position.

On the other hand, when the development unit 50 and the toner cartridge 70 are in the position TP3, the cover 254 is in the cover retraction position. The position where the development roller 51 of the development unit 50 is opposed to the photosensitive drum 2 is downstream of the position TP3 and upstream of the position TP4. In other words, while the posture of the rotary main body 90 changes from the replacement posture to the development posture, the rotary main body 90 is in the cover retraction posture, and the cover 254 is in the cover retraction position. In the present exemplary embodiment, when the development unit 50 is in the development position, the reception opening 53b is in the position below the discharge opening 71b, and the cover 254 is in the cover retraction position.

When the rotary main body 90 rotates, after the development unit 50 and the toner cartridge 70 pass through the position TP2, the cover 254 moves to the cover retraction position. Before the development unit 50 and the toner cartridge 70 reach the position TP4, the cover 254 moves to the cover position. As a result, in the state in which at least a part of the reception opening 53b is in the position above the discharge opening 71b, the cover 254 is in the cover position, and the backflow of toner from the development unit 50 to the toner cartridge 70 is prevented more securely.

In the present exemplary embodiment, a plurality of reception openings 53b is included in the development frame 53. Further, the development unit 50 includes a plurality of covers 254. In other words, the development opening includes a plurality of reception openings 53b, and the restriction portion (the toner regulating portion) includes a plurality of covers 254. When the plurality of covers 254 is in the cover position, the plurality of covers 254 covers the plurality of reception openings 53b. When the plurality of covers 254 is in the cover retraction position, toner discharged from the toner cartridge 70 is allowed to pass through a gap between the plurality of covers 254 and the plurality of reception openings 53b and enter the development side storage portion 53a.

Although the number of reception openings 53b is two in the present exemplary embodiment, the number of reception openings 53b may be one, or may be more than two. The cover 254 is placed corresponding to each reception opening 53b. Thus, the number of covers 254 may be one, or may be more than two.

As illustrated above, according to the present invention, the backflow of toner from the development unit 50 to the toner cartridge 70 is prevented.

According to the present invention, it is possible to provide an image forming apparatus in a novel form advanced from a conventional technique.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2024-000583, filed Jan. 5, 2024, No. 2024-000584, filed Jan. 5, 2024, and No. 2024-205840, filed Nov. 26, 2024, which are hereby incorporated by reference herein in their entirety.

What is claimed is:

1. An image forming apparatus comprising:
a development unit including a development roller, a development frame including a reception side storage chamber and a development opening communicating with the reception side storage chamber, a toner regulating portion configured to move to a cover position where the toner regulating portion covers the development opening and a retraction position where the toner regulating portion is retracted from the cover position, and an abutment portion linked to the toner regulating portion;
a rotary supporting the development unit and configured to rotate about a rotational axis extending in an axis direction;
a holding portion configured to abut the abutment portion; and
a toner cartridge attachable to and detachable from the rotary, the toner cartridge including a toner frame including (i) a replenishment side storage chamber storing toner and (ii) a discharge port communicating with the replenishment side storage chamber,
wherein in a case where the rotary rotates, the abutment portion moves relative to the holding portion,
wherein in a case where the rotary is in a first posture, the development opening is in a position above the discharge port, and the holding portion and the abutment portion abut each other in such a manner that the toner regulating portion is in the cover position, and
wherein in a case where the rotary is in a second posture, the development opening is in a position below the discharge port, the toner regulating portion is in the retraction position, and toner discharged from the discharge port is allowed to enter the reception side storage chamber.

2. The image forming apparatus according to claim 1, further comprising a rotary holder supporting the rotary and including the holding portion.

3. The image forming apparatus according to claim 2, wherein the rotary holder is configured to swing in such a manner that the rotational axis of the rotary is displaced.

4. The image forming apparatus according to claim 1, wherein in the case where the rotary is in the first posture, the holding portion is configured to restrict the toner regulating portion from moving from the cover position to the retraction position.

5. The image forming apparatus according to claim 1, wherein in the case where the rotary is in the second posture, the holding portion and the abutment portion abut each other in such a manner that the toner regulating portion is in the retraction position.

6. The image forming apparatus according to claim 5, wherein in the case where the rotary is in the second posture, the holding portion is configured to restrict the toner regulating portion from moving from the retraction position to the cover position.

7. The image forming apparatus according to claim 1, wherein the holding portion forms a groove into which the abutment portion is inserted.

8. The image forming apparatus according to claim 1, wherein the toner regulating portion is configured to swing between the cover position and the retraction position.

9. The image forming apparatus according to claim 1, wherein the abutment portion is disposed outside the reception side storage chamber.

10. The image forming apparatus according to claim 1,
wherein the development opening includes a plurality of openings,
wherein the toner regulating portion includes a plurality of covers, and
wherein in a case where the toner regulating portion is in the cover position, the plurality of covers covers the plurality of openings, and in a case where the toner regulating portion is in the retraction position, toner discharged from the toner cartridge is allowed to enter the reception side storage chamber.

11. The image forming apparatus according to claim 1, wherein the toner regulating portion is accommodated in the reception side storage chamber.

12. The image forming apparatus according to claim 1, wherein in a case where the rotary is in a replacement posture in which the toner cartridge is allowed to be attached to and detached from the rotary, the development opening is in the position above the discharge port, and the toner regulating portion is in the cover position.

13. The image forming apparatus according to claim 12, further comprising:
a photosensitive drum,
wherein in a case where the rotary is in a development posture, the development roller is opposed to the photosensitive drum, and
wherein while a posture of the rotary changes from the replacement posture to the development posture, the rotary is in the second posture.

14. An image forming apparatus comprising:
a development unit including a development roller, a development frame including a reception side storage chamber and a development opening communicating with the reception side storage chamber, and a toner regulating portion configured to move to a cover position where the toner regulating portion covers the development opening and a retraction position where the toner regulating portion is retracted from the cover position;
a rotary supporting the development unit and configured to rotate about a rotational axis extending in an axis direction; and
a toner cartridge attachable to and detachable from the rotary, the toner cartridge including a toner frame including (i) a replenishment side storage chamber storing toner and (ii) a discharge port communicating with the replenishment side storage chamber,
wherein the toner regulating portion is configured to move between the cover position and the retraction position under a weight of the toner regulating portion itself,
wherein in a case where the rotary to which the toner cartridge is attached is in a first posture, the development opening is in a position above the discharge port, and an own weight of the toner regulating portion acts from the retraction position toward the cover position in such a manner that the toner regulating portion is in the cover position,
wherein in a case where the rotary to which the toner cartridge is attached is in a second posture, the development opening is in a position below the discharge port, an own weight of the toner regulating portion acts from the cover position toward the retraction position in such a manner that the toner regulating portion is in the retraction position, and toner discharged from the discharge port is allowed to enter the reception side storage chamber, and
wherein the toner regulating portion includes one end portion fixed to the development frame and an other end portion opposite to the one end portion, and in a case where the toner regulating portion moves between the cover position and the retraction position, the toner regulating portion elastically deforms between the one end portion and the other end portion.

15. The image forming apparatus according to claim 14, wherein when viewed in the axis direction, the other end portion is closer to the rotational axis than the one end portion is.

16. The image forming apparatus according to claim 13,
wherein the development opening includes a plurality of openings,
wherein the toner regulating portion includes a plurality of covers, and
wherein in a case where the toner regulating portion is in the cover position, the plurality of covers covers the plurality of openings, and in a case where the toner regulating portion is in the retraction position, toner discharged from the toner cartridge is allowed to enter the reception side storage chamber.

17. The image forming apparatus according to claim 14, wherein the toner regulating portion is accommodated in the reception side storage chamber.

18. The image forming apparatus according to claim 14, wherein in a case where the rotary is in a replacement posture in which the toner cartridge is allowed to be attached to and detached from the rotary, the development opening is in the position above the discharge port, and the toner regulating portion is in the cover position.

19. The image forming apparatus according to claim 18, further comprising:
a photosensitive drum,
wherein in a case where the rotary is in a development posture, the development roller is opposed to the photosensitive drum, and
wherein while a posture of the rotary changes from the replacement posture to the development posture, the rotary is in the second posture.
